(19) United States
(12) Patent Application Publication
(10) Pub. No.: US 2025/0191504 A1
(43) Pub. Date: Jun. 12, 2025

(54) DISPLAY CONTROL METHOD, DISPLAY CONTROL DEVICE, AND DISPLAY CONTROL SYSTEM

(71) Applicant: Panasonic Automotive Systems Co., Ltd., Kanagawa (JP)

(72) Inventors: Masataka KATO, Kanagawa Ken (JP); Koichi EMURA, Kanagawa Ken (JP)

(73) Assignee: Panasonic Automotive Systems Co., Ltd., Kanagawa (JP)

(21) Appl. No.: 18/972,404

(22) Filed: Dec. 6, 2024

(30) Foreign Application Priority Data
Dec. 12, 2023 (JP) 2023-209646

(51) Int. Cl. G09G 3/00; B60Q 9/00; G06V 20/59

(52) U.S. Cl. CPC G09G 3/002; G06V 20/597; B60Q 9/00; G09G 2320/0626; G09G 2320/0666; G09G 2380/10

(57) ABSTRACT

A display control method according to the present disclosure includes: acquiring a first image corresponding to a field of view of a driver in a vehicle interior including a display area; generating a second image by adding, in a first display form, a display object by a display to the display area in the first image; estimating an attention state of the driver by applying one or more attention estimation models to the second image; and controlling a display form of the display object to be displayed by the display in the display area in the vehicle interior, depending on an estimation result of the attention state.

### CROSS-REFERENCE TO RELATED APPLICATIONS

This application is based upon and claims the benefit of priority from Japanese Patent Application No. 2023-209646, filed Dec. 12, 2023, the entire contents of which are incorporated herein by reference.

### FIELD

The present disclosure relates to a display control method, a display control device, and a display control system.

### BACKGROUND

There are cases where a display such as a head-up display is controlled to display a display object in a predetermined display area in a vehicle interior. As a result, information can be transmitted to the driver, and driving assistance of the driver can be performed.

Related techniques are described in JP 2017-111649 A and JP 2018-90170 A.

In order to appropriately transmit information to a driver, it is desirable to control a display in such a manner as to appropriately display a display object.

The present disclosure provides a display control method, a display control device, and a display control system capable of appropriately displaying a display object.

### SUMMARY

A display control method according to the present disclosure includes: acquiring a first image corresponding to a field of view of a driver in a vehicle interior including a display area; generating a second image by adding, in a first display form, a display object by a display to the display area in the first image; estimating an attention state of the driver by applying one or more attention estimation models to the second image; and controlling a display form of the display object to be displayed by the display in the display area in the vehicle interior, depending on an estimation result of the attention state.

### BRIEF DESCRIPTION OF THE DRAWINGS

FIG. 1 is a diagram schematically illustrating a vehicle in which a display control method according to a first embodiment is executed;

FIG. 2 is a diagram illustrating a field of view of a driver according to the first embodiment;

FIG. 3 is a diagram illustrating a hardware configuration of a display control system according to the first embodiment;

FIG. 4 is a diagram illustrating a functional configuration of a display control device according to the first embodiment;

FIG. 5 is a flowchart illustrating the display control method according to the first embodiment;

FIGS. 6A to 6D are flowcharts illustrating the display control method according to the first embodiment;

FIGS. 7A to 7D are diagrams illustrating the display control method according to a first modification of the first embodiment;

FIGS. 8A to 8C are diagrams illustrating a display control method according to a second modification of the first embodiment;

FIGS. 9A to 9D are diagrams illustrating a display control method according to a third modification of the first embodiment;

FIGS. 10A to 10D are diagrams illustrating a display control method according to a fourth modification of the first embodiment;

FIGS. 11A to 11D are diagrams illustrating a display control method according to a fifth modification of the first embodiment;

FIGS. 12A to 12D are diagrams illustrating a display control method according to a sixth modification of the first embodiment;

FIGS. 13A to 13D are diagrams illustrating a display control method according to a seventh modification of the first embodiment;

FIG. 14 is a diagram illustrating a functional configuration of a display control device according to a second embodiment;

FIG. 15 is a flowchart illustrating a display control method according to a second embodiment;

FIG. 16 is a diagram illustrating a display control method according to the second embodiment;

FIG. 17 is a diagram illustrating the display control method according to the second embodiment;

FIG. 18 is a diagram illustrating a functional configuration of a display control device according to a first modification of the second embodiment;

FIGS. 19A to 19H are diagrams illustrating a display control method according to the first modification of the second embodiment;

FIG. 20 is a flowchart illustrating the display control method according to the first modification of the second embodiment;

FIG. 21 is a diagram illustrating a functional configuration of a display control device according to a second modification of the second embodiment;

FIG. 22 is a flowchart illustrating a display control method according to the second modification of the second embodiment;

FIG. 23 is a flowchart illustrating a display control method according to a third modification of the second embodiment;

FIG. 24 is a diagram illustrating the display control method according to the third modification of the second embodiment;

FIG. 25 is a flowchart illustrating a display control method according to a fourth modification of the second embodiment;

FIG. 26 is a diagram illustrating the display control method according to the fourth modification of the second embodiment;

FIG. 27 is a diagram illustrating the display control method according to the fourth modification of the second embodiment;

FIG. 28 is a flowchart illustrating a display control method according to a fifth modification of the second embodiment;

FIG. 29 is a diagram illustrating the display control method according to the fifth modification of the second embodiment; and

FIG. 30 is a diagram illustrating a display method according to a third embodiment.

### DETAILED DESCRIPTION

Hereinafter, embodiments of a display control device according to the present disclosure will be described with reference to the drawings.

### First Embodiment

In a display control method according to a first embodiment, a display such as a head-up display is controlled to display a display object in a display area in a vehicle interior, in which a device for appropriately displaying the display object is put in place.

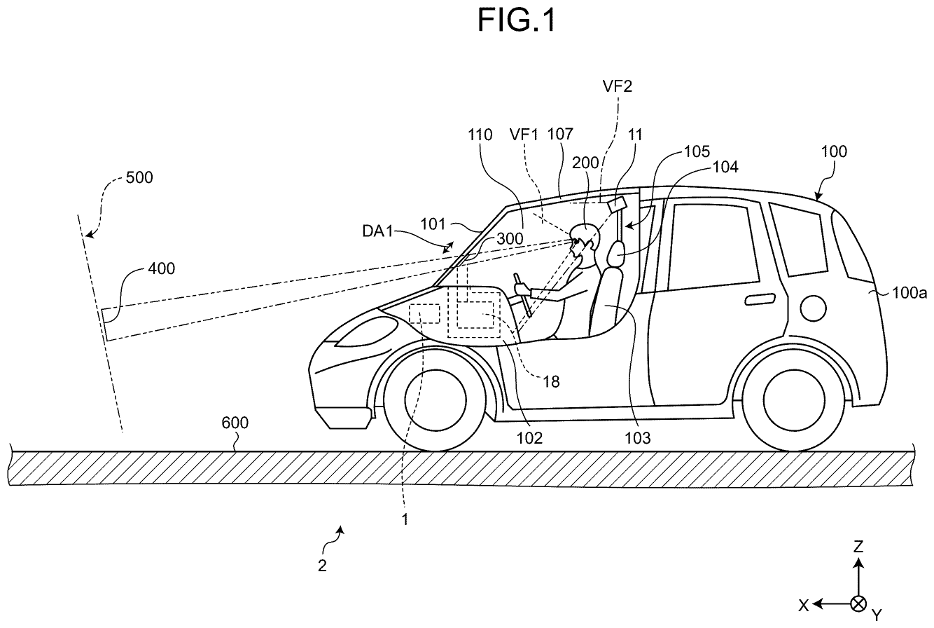

The display control method is executed in a vehicle 100 as illustrated in FIG. 1. FIG. 1 is a diagram schematically illustrating a vehicle in which the display control method is executed.

The vehicle 100 is any traveling body capable of traveling on a road surface 600. The vehicle 100 may be a two-wheeled vehicle, a three-wheeled vehicle, a four-wheeled vehicle, a traveling body having five or more wheels, or a traveling body having no wheels. Hereinafter, description will be given mainly for a case where the vehicle 10 is a four-wheeled vehicle. The traveling direction of the vehicle 100 is referred to as an X direction, a direction perpendicular to the road surface 600 is referred to as a Z direction, and a direction perpendicular to the X direction and the Z direction is referred to as a Y direction.

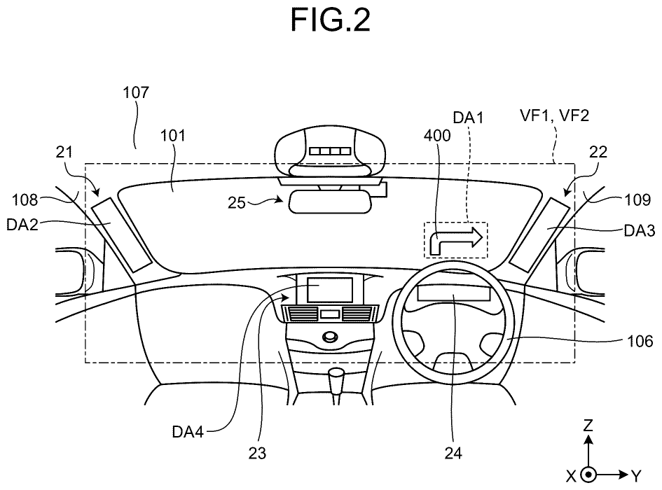

In the vehicle 100, by being surrounded by a substantially box-shaped vehicle body 100a, a vehicle interior 110 is formed. A driver 200 can be seated on a driver's seat 103 in the vehicle interior 110. The driver 200 can visually recognize a field of view VF1 of a dotted line in the normal posture. As illustrated in FIG. 2, the dotted field of view VF1 includes a windshield 101 on the +X side and a member in an area in the XY directions of the windshield 101 (for example, a steering wheel 106). The steering wheel 106 may be operated by the driver 200.

An imaging sensor 11 is mounted in the vehicle interior 110 illustrated in FIG. 1. The imaging sensor 11 has an imaging range VF2. The imaging range VF2 corresponds to the field of view VF1. In the vehicle interior 110, the imaging sensor 11 is disposed at any position where the imaging range VF2 corresponding to the field of view VF1 can be secured. FIG. 1 illustrates a configuration in which a headrest 104 is disposed on the +Z side of the driver's seat 103, and the imaging sensor 11 is connected on the +Z side of the headrest 104 via a frame 105. As illustrated in FIG. 2, the imaging range VF2 may substantially coincide with the field of view VF1. Accordingly, the imaging sensor 11 can capture an image of the imaging range VF2 and acquire an image IM1 of the imaging range VF2. The image IM1 corresponds to the field of view VF1 of the driver 200.

The vehicle 100 is further mounted with a display 18 and a display control device 1 that controls the display 18. The display 18 can display a display object in a display area DA1 in the vehicle interior 110. The display area DA1 may be located in the windshield 101 near the +Z-side end of the steering wheel 106.

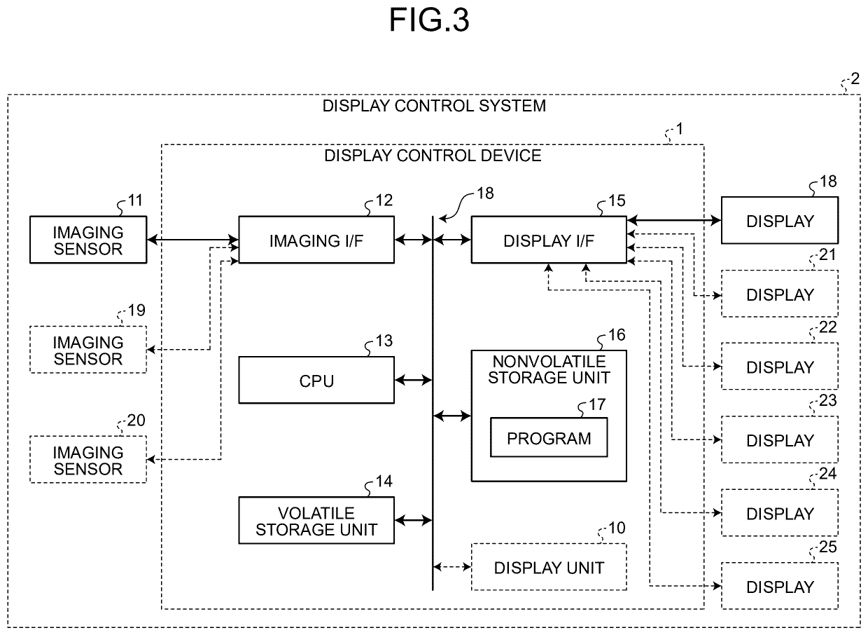

The configuration including the imaging sensor 11, the display control device 1, and the display 18 functions as a display control system 2 that executes the display control method. The display control system 2 may be configured as illustrated in FIG. 3 in terms of hardware. FIG. 3 illustrates a hardware configuration of the display control system 2.

In the display control system 2, the display control device 1 is connected between the imaging sensor 11 and the display 18.

The display control device 1 includes an imaging interface (I/F) 12, a CPU 13, a volatile storage unit 14, a display interface (I/F) 15, a nonvolatile storage unit 16, and a bus 18. The imaging interface 12, the CPU 13, the volatile storage unit 14, the display interface 15, and the nonvolatile storage unit 16 are communicatively connected to each other via the bus 18.

The CPU 13 integrally controls the units of the display control device 1.

The imaging interface 12 is communicatively connected to the imaging sensor 11 via a communication medium such as a communication line. The imaging interface 12 performs an interface operation to the imaging sensor 11 under the control by the CPU 13.

The volatile storage unit 14 temporarily stores information. The volatile storage unit 14 can also be used as a work area of the CPU 13.

The nonvolatile storage unit 16 nonvolatilely stores information. The nonvolatile storage unit 16 may store a program 17 for executing the display control method.

The display interface 15 is communicatively connected to the display 18 via a communication medium such as a communication line. The display interface 15 performs an interface operation on the display 18 under the control by the CPU 13.

The display 18 illustrated in FIG. 1 may be a head-up display. The display 18 is disposed in a space 102 included on the −Z side of the windshield 101. The space 102 may be a dashboard. The space 102 has an opening on the +Z side. The display 18 can emit light to the display area DA1 in the windshield 101 from the −Z side of the windshield 101 through the opening.

As a result, when the display 18 projects a display object 300 on the display area DA1, the display object 300 reflected by the windshield 101 as the display medium can be visually recognized by the driver 200. The display 18 projects a display object 400 as a virtual image on a virtual screen 500 disposed in front of the vehicle 100. As illustrated in FIG. 2, the driver 200 visually recognizes the display object 400 through the windshield 101.

The display 18 allows the driver 200 to visually recognize the display object 400 indicating driving assistance information. The driving assistance information includes, for example, vehicle speed information, navigation information, pedestrian information, preceding vehicle information, lane deviation information, and a vehicle condition. The navigation information includes right turn guidance, left turn guidance, straight traveling guidance, stopping guidance, stop guidance, parking guidance, right lane change guidance, left lane change guidance, and others. FIG. 2 illustrates a case where the display 18 displays the display object 400 of an arrow indicating right turn guidance.

As a result, the display 18 can perform driving assistance of the driver 200 by displaying a display object in the display area DA1 to transmit driving assistance information to the driver 200.

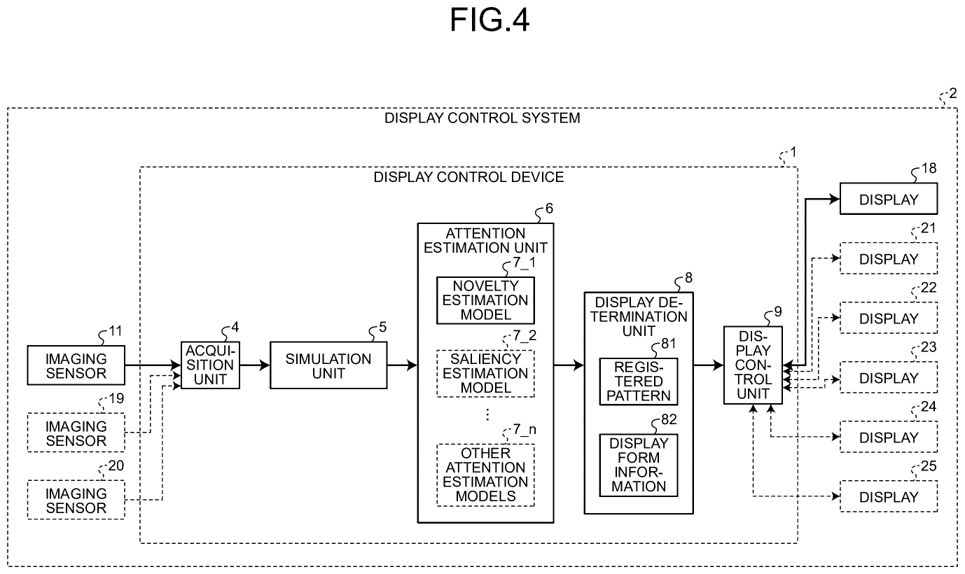

Next, a functional configuration of the display control device 1 will be described with reference to FIG. 4. FIG. 4 is a diagram illustrating a functional configuration of the display control device 1.

The display control device 1 includes an acquisition unit 4, a simulation unit 5, an attention estimation unit 6, a display determination unit 8, and a display control unit 9. In the display control device 1, the units illustrated in FIG. 4 may be implemented hardware-wise (for example, as circuits), may be implemented software-wise, or may be partially implemented hardware-wise with the remainder implemented software-wise. In the case where the units illustrated in FIG. 4 are implemented software-wise, the CPU 13 (see FIG. 3) may execute the program 17 to functionally configure the units illustrated in FIG. 4 on the volatile storage unit 14 collectively at the time of compilation or sequentially as the processing progresses.

The imaging sensor 11 captures an image of the imaging range VF2 (see FIG. 2) in the vehicle interior 110 and acquires the image IM1. In a case where the imaging range VF2 corresponds to the field of view VF1, the image IM1 corresponds to the field of view VF1 of the driver 200 and can be regarded as a visual field image. The image IM1 includes the display area DA1. The imaging sensor 11 supplies the image IM1 to the display control device 1.

The acquisition unit 4 receives the image IM1 from the imaging sensor 11. The acquisition unit 4 can acquire a visual field image using the image IM1. The acquisition unit 4 may use the image IM1 as the visual field image as it is. The acquisition unit 4 supplies the image IM1 to the simulation unit 5.

The simulation unit 5 receives the image IM1 from the acquisition unit 4. The simulation unit 5 generates an image IM2 using the image IM1. The simulation unit 5 may generate the image IM2 by adding the display object 400 to the display area DA1 of the image IM1 in a display form DF1. The display form DF1 includes brightness BR1. The simulation unit 5 supplies the image IM2 to the attention estimation unit 6.

The attention estimation unit 6 receives the image IM2 from the simulation unit 5. The attention estimation unit 6 includes one or more attention estimation models 7. The attention estimation unit 6 estimates the attention state of the driver 200 by applying the one or more attention estimation models 7 to the image IM2. The attention estimation model 7 is a learned model in which learning for estimating an attention state has been performed on the basis of the mechanism of human cognition. FIG. 4 illustrates an exemplary case where the attention estimation unit 6 includes a novelty estimation model 7_1. The novelty estimation model 7_1 is a learned model in which learning for estimating a novelty has been performed on the basis of the mechanism of human cognition.

Novelty is a feature related to human attention and is based on the predictive coding theory and the free energy principle. It is conceivable that the human brain always predicts the external world, and in a case where a prediction by the brain turns out to be incorrect, attention is paid in an attempt to proactively capture information of a point where the prediction is incorrect in order to minimize an error between the prediction of the external world by the brain and the perceived stimulation of the external world. The larger the prediction error or a change in the prediction error is, the higher the novelty tends to be.

The novelty estimation model 7_1 can generate map information MP indicating a two-dimensional distribution of prediction errors corresponding to the current image by generating a current prediction image from visual field images at a plurality of time points in the past and comparing the current image with the prediction images. The larger the prediction error is, the higher the novelty tends to be, and thus the map information MP also indicates a two-dimensional distribution of novelty.

The attention estimation unit 6 inputs the visual field images at the plurality of time points in the past and the image IM2 to the attention estimation model 7. The attention estimation model 7 generates a current prediction image from the visual field images at the plurality of time points in the past and two-dimensionally obtains a feature amount related to an attention state of a person on the basis of the image IM2 and the prediction image. The attention estimation model 7 estimates the attention state depending on a distribution of the two-dimensional feature amount and outputs the estimation result of the attention state to the attention estimation unit 6. The attention estimation unit 6 supplies the estimation result of the attention state to the display determination unit 8.

In a case where the attention estimation model 7 is the novelty estimation model 7_1, the attention estimation unit 6 inputs the visual field images at the plurality of time points in the past and the image IM2 to the novelty estimation model 7_1. The novelty estimation model 7_1 generates the current prediction image from the visual field images at the plurality of time points in the past, two-dimensionally obtains the prediction error related to human cognition on the basis of the image IM2 and the prediction image, and generates map information MP indicating a distribution of the two-dimensional prediction errors. The novelty estimation model 7_1 outputs the map information MP to the attention estimation unit 6. The attention estimation unit 6 supplies an estimation result of the attention state including the image IM2 and the map information MP to the display determination unit 8.

The display determination unit 8 receives the estimation result of the attention state from the attention estimation unit 6. The display determination unit 8 determines the display form of the display object 400 to be displayed by the display 18 in the display area DA1 in the vehicle interior 110 depending on the estimation result of the attention state.

In a case where the estimation result of the attention state is a first estimation result, the display determination unit 8 changes the display form of the display object 400 from the display form DF1 to the display form DF2. The first estimation result indicates that excessive attention is focused on the display object 400 in the field of view VF1. The display form DF2 is a display form in which the attention is suppressed as compared with the display form DF1.

In a case where the estimation result of the attention state is a second estimation result, the display determination unit 8 maintains the display form of the display object 400 in the display form DF1. The second estimation result indicates that the degree of focus of attention on the display object 400 in the field of view VF1 is within an allowable range.

For example, the display form DF1 may include displaying the display object 400 at brightness BR1, and the display form DF2 may include displaying the display object 400 at brightness BR2. The brightness BR2 is lower than the brightness BR1.

The display form DF1 may include displaying the display object 400 at the brightness BR1, and the display form DF2 may include displaying the display object by gradually increasing the brightness from the brightness BR2.

The display form DF1 may include displaying the display object in color CL1, and the display form DF2 may include displaying the display object in a color CL2. The color CL1 may include saturation and hue of the display object 400 or may include any combination of brightness, saturation, and hue. Color CL2 may be a color in which at least one of saturation or hue is different from those of the color CL1 and attention is suppressed as compared with the color CL1. Color CL2 may be a color in which one or more of brightness, saturation, and hue are different from those of the color CL1 and attention is suppressed as compared with the color CL1.

The display form DF1 includes displaying the display object 400 immediately, and the display form DF2 includes displaying the display object 400 after time Δt has elapsed. The time Δt can be experimentally determined in advance as a time sufficient to suppress attention.

In a case where the estimation result of the attention state includes an image IM2 and the map information MP, the display determination unit 8 may specify the attention state pattern depending on the image IM2 and the map information MP2. The display determination unit 8 may include a registered pattern 81 and display form information 82. The registered pattern 81 includes one or more attention state patterns experimentally determined in advance as attention state patterns in which attention is excessively focused on the display object 400 in the field of view VF1. In the display form information 82, for one or more attention state patterns, the attention state pattern and the display form to be modified may be associated with each other. Alternatively, in the display form information 82, for one or more attention state patterns, the attention state pattern and the modification amount of the display form may be associated with each other.

In a case where the attention state pattern matches the registered pattern 81, the display determination unit 8 refers to the display form information 82 and changes the display form of the display object 400 from the display form DF1 to the display form DF2. The display form DF2 is a display form in which the attention is suppressed as compared with the display form DF1. In the display form information 82, a display form in which attention is suppressed may be experimentally acquired in advance for each of the one or more attention state patterns, and the acquired display forms may be included in a form associated with the attention state patterns as display forms to be modified to. Alternatively, in the display form information 82, a display form in which attention is suppressed may be experimentally acquired in advance for each of the one or more attention state patterns, and differences between the acquired display forms and a standard display form may be included in a form associated with the attention state patterns as the modification amounts of the display form.

In a case where the attention state pattern does not match the registered pattern 81, the display determination unit 8 maintains the display form of the display object 400 in the display form DF1.

The display determination unit 8 supplies the determined display form to the display control unit 9 as the display form of the display object 400.

The display control unit 9 receives the display form of the display object 400 from the display determination unit 8. The display control unit 9 generates a control signal depending on the display form of the display object 400 and supplies the control signal to a display unit 10.

The display unit 10 receives the control signal from the display control unit 9 and displays the display object 400 in the display form corresponding to the control signal in the display area DA1 in the vehicle interior 110. As a result, in such a case where displaying the display object 400 in the display form DF1 results in excessive attention focused on the display object 400 in the field of view VF1, the display object 400 can be displayed in the display area DA1 in the display form DF2 in which the attention is suppressed as compared with the display form DF1.

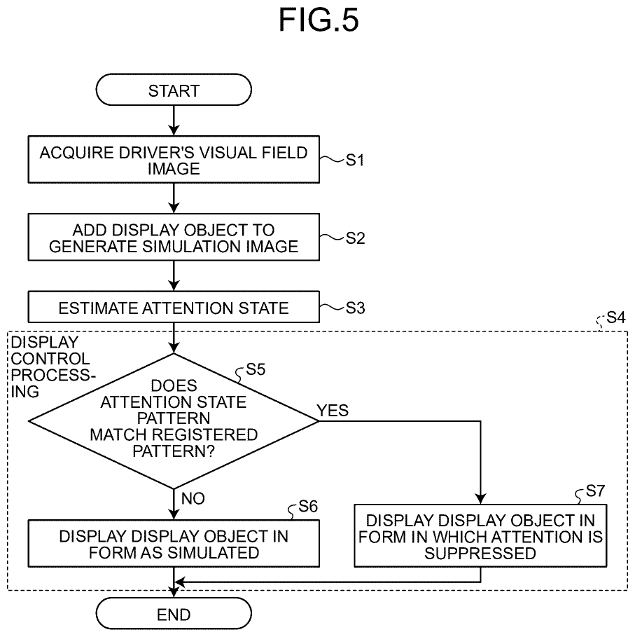

Next, the display control method executed by the display control system 2 will be described with reference to FIG. 5. FIG. 5 is a flowchart illustrating the display control method.

In the display control system 2, the display control device 1 acquires the image IM1, in which the imaging range VF2 is captured by the imaging sensor 11, from the imaging sensor 11 as a visual field image (S1). The display control device 1 generates the image IM2 as a simulation image by adding the display object 400 to the display area DA1 of the image IM1 in the display form DF1 (S2).

The display control device 1 applies the attention estimation model 7 to the image IM2 to estimate the attention state of the driver 200 (S3) and generates an estimation result of the attention state. The display control device 1 may apply the novelty estimation model 7_1 to the image IM2 to generate the map information MP indicating a two-dimensional distribution of prediction errors corresponding to the image IM2 and generate an estimation result of the attention state including the image IM2 and the map information MP.

The display control device 1 performs display control processing depending on the estimation result of the attention state (S4). In the display control processing (S4), the display form of the display object 400 to be displayed by the display 18 in the display area DA1 in the vehicle interior 110 is determined depending on the estimation result of the attention state, and the display 18 is controlled to display the display object 400 in the determined display form.

In a case where the estimation result of the attention state includes the image IM2 and the map information MP, the display control device 1 may specify the attention state pattern. The display control device 1 determines whether or not the attention state pattern matches the registered pattern 81 (S5).

In a case where the attention state pattern does not match the registered pattern 81 (No in S5), the display control device 1 determines the display form DF1 as the display form of the display object 400 in accordance with the simulation image in S2. The display control device 1 controls the display 18 to display the display object 400 in the display area DA1 in the vehicle interior 110 in the display form DF1 (S6).

In a case where the attention state pattern matches the registered pattern 81 (Yes in S5), the display control device 1 refers to the display form information 82 and changes the display form of the display object 400 to the display form DF2. The display form DF2 is a display form in which attention is suppressed as compared with the display form DF1 of the simulation image in S2. The display control device 1 controls the display 18 to display the display object 400 in the display area DA1 in the vehicle interior 110 in the display form DF2 (S7).

As described above, in the first embodiment, the display control method includes acquiring a visual field image, generating a simulation image from the visual field image, applying an attention estimation model to the simulation image to estimate the attention state of the driver 200, and controlling the display form of the display object 400 by the display 18 depending on the estimation result. For example, in a case where the attention state pattern matches the registered pattern 81, the display form of the display object 400 is changed from the display form DF1 of the simulation image to the display form DF2 in which attention is suppressed more. As a result, in such a case where displaying the display object 400 in the display form DF1 results in excessive attention focused on the display object 400 in the field of view VF1, the display object 400 can be displayed in the display area DA1 in the display form DF2 in which the attention is suppressed as compared with the display form DF1. As a result, the degree of concentration of attention on the display object 400 in the field of view VF1 can be kept within an allowable range.

Note that the concept of the present embodiment is not limited to the display 18 (for example, the head-up display) but can be applied to any display that falls within the field of view of the driver 200. The display control system 2 may include displays 21 to 25 indicated by dotted lines in FIGS. 3 and 4 instead of the display 18 or may include displays 21 to 25 in addition to the display 18. The destination of the control signal from the display control device 1 may be any of the displays 21 to 25 instead of the display 18. The displays 21 and 22 are provided on pillars 108 and 109 that support a roof portion 107 of the vehicle body 100a on both sides in the Y direction of the windshield 101 and are also referred to as pillar displays. The display 23 is disposed in the vicinity of the front center of the vehicle interior 100 and is also referred to as a center display. The display 24 displays a speedometer or the like and is also referred to as a meter display. The display 25 functions as a substitute for the room mirror by displaying the rear image acquired by an imaging sensor and is also referred to as an electronic mirror.

Meanwhile, the novelty estimation model 7_1 illustrated in FIG. 4 may generate map information MP indicating the distribution of variance of the two-dimensional prediction errors instead of the map information MP indicating the distribution of values of the two-dimensional prediction errors. In this case, the attention estimation unit 6 may receive the map information MP from the novelty estimation model 7_1 and estimate the attention state depending on the distribution of the variance of the two-dimensional prediction errors indicated by the map information MP.

Alternatively, the novelty estimation model 7_1 may generate map information MP indicating a distribution of combinations of values and variances of the two-dimensional prediction errors. In this case, the attention estimation unit 6 may receive the map information MP from the novelty estimation model 7_1 and estimate the attention state depending on the distribution of the combinations of the values and variances of the two-dimensional prediction errors indicated by the map information MP.

In addition, the visual field image may be acquired by combining images of a plurality of imaging sensors instead of being acquired by one imaging sensor. In this case, instead of the imaging sensor 11, the display control system 2 may include a plurality of imaging sensors 19 and 20 indicated by dotted lines in FIGS. 3 and 4. In the vehicle interior 110 illustrated in FIG. 1, the imaging sensor 19 may be disposed on the +Y side of the driver 200 and acquire an image IM01 by imaging a region corresponding to the +Y side of the field of view VF1, and the imaging sensor 20 may be disposed on the −Y side of the driver 200 and acquire an image IM02 by imaging a region corresponding to the −Y side of the field of view VF1. The acquisition unit 4 illustrated in FIG. 4 may acquire an image IM1 by receiving the image IM01 from the imaging sensor 19, receiving the image IM02 from the imaging sensor 20, and combining the image IM01 and the image IM02. The image IM1 can be deemed as a visual field image corresponding to the field of view VF1.

Also with such a plurality of imaging sensors 19 and 20, the display control system 2 can acquire a visual field image corresponding to the field of view VF1 of the driver 200.

In addition, the attention estimation unit 6 illustrated in FIG. 4 may include a plurality of attention estimation models 7. The plurality of attention estimation models 7 may include a saliency estimation model 7_2, . . . , and another attention estimation model 7_n in addition to the novelty estimation model 7_1. The value n is any integer greater than or equal to 3.

The saliency estimation model 7_2 is an algorithm that extracts conspicuous image features on the basis of a mechanism of human perception. Saliency is rooted in the feature integration theory and is an attention indicator obtained, as a visual feature different from the surroundings, by classifying a video by features (brightness, colors, and orientation). There is also a definition of saliency as “a feature that sensory stimulus attracts bottom-up attention”; however, saliency is defined herein as a feature that attention is attracted by a spatial feature of visual stimuli.

The attention estimation unit 6 may apply the plurality of attention estimation models 7 to the image IM2, obtain a plurality of estimation results of the attention state, combine the plurality of estimation results by weighted addition of the estimation results, and supply the combined estimation result to the display determination unit 8.

Such an attention estimation unit 6 can also estimate the attention state of the driver 200.

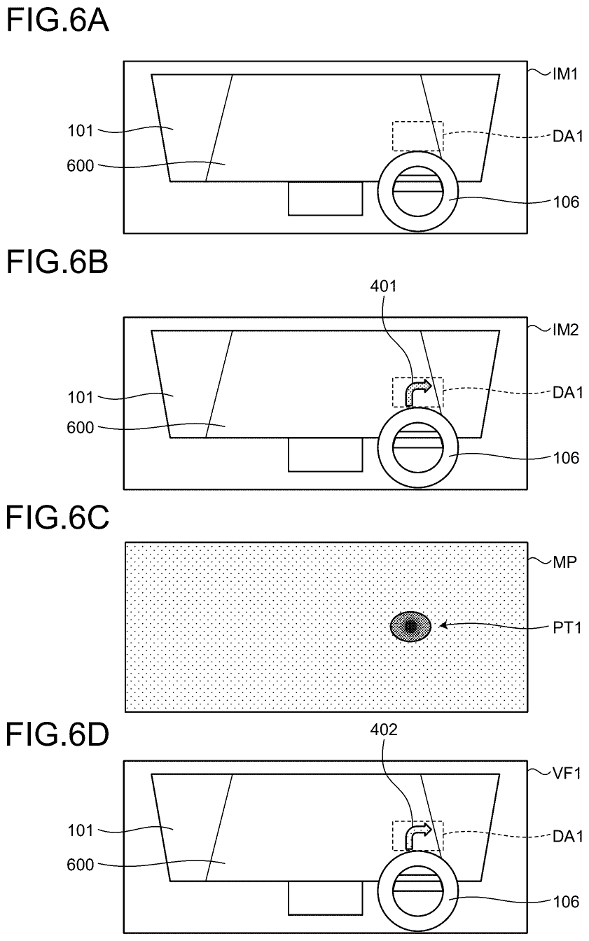

As a first modification of the first embodiment, display control as illustrated in FIGS. 6A to 6D may be performed. FIGS. 6A to 6D are diagrams illustrating a display control method according to the first modification of the first embodiment.

For example, let us assume that an attention state pattern as illustrated by an image IM2 in FIG. 6B and map information MP in FIG. 6C is included in the registered pattern 81 in advance.

In S1 of FIG. 5, the imaging range VF2 is captured, and an image IM1 as illustrated in FIG. 6A is acquired. The image IM1 illustrates a situation where there is no object on the road surface 600 for a certain period of time.

In S2 of FIG. 5, a display object 401 is added at the brightness BR1 to the display area DA1 in the image IM1, whereby the image IM2 as illustrated in FIG. 6B is generated.

In S3 of FIG. 5, the attention estimation model 7 is applied to the image IM2, the attention state of the driver 200 is estimated, and the map information MP as illustrated in FIG. 6C is generated. The map information MP corresponds to the image IM2. In the map information MP, by referring to the image IM2, it is indicated that a pattern PT1, whose novelty level is greater than or equal to a threshold level Lth1, is included at a position corresponding to the display area DA1. The threshold level Lth1 can be experimentally determined in advance as a novelty level corresponding to excessive concentration of attention.

In S5 of FIG. 5, it is determined that the attention state pattern specified by the image IM2 of FIG. 6B and the map information MP of FIG. 6C matches the registered pattern 81.

In S7 of FIG. 5, the brightness of the display object 400 is changed to the brightness BR2 which is lower than the brightness BR1. The display 18 is controlled at the brightness BR2, and the display 18 displays a display object 402 at the brightness BR2 in the display area DA1 in the field of view VF1 as illustrated in FIG. 6D.

Also with such display control, in such a case where displaying the display object 400 at the brightness BR1 results in excessive attention focused on the display object 400 in the field of view VF1, the display object 400 can be displayed in the display area DA1 at the brightness BR2 at which the attention is suppressed as compared with the brightness BR1. As a result, the degree of concentration of attention on the display object 400 in the field of view VF1 can be kept within an allowable range.

Alternatively, in S1 of FIG. 5, the imaging range VF2 is captured, and the image IM1 as illustrated in FIG. 6A is acquired. The image IM1 illustrates a situation where there is no object on the road surface 600 for a certain period of time.

In S3 of FIG. 5, the attention estimation model 7 is applied to the image IM2, the attention state of the driver 200 is estimated, and the map information MP as illustrated in FIG. 6C is generated. The map information MP corresponds to the image IM2. In the map information MP, by referring to the image IM2, it is indicated that a pattern PT1, whose novelty level is greater than or equal to a threshold level Lth1, is included at a position corresponding to the display area DA1. The threshold level Lth1 can be experimentally determined in advance as a novelty level corresponding to excessive concentration of attention.

In S5 of FIG. 5, it is determined that the attention state pattern specified by the image IM2 of FIG. 6B and the map information MP of FIG. 6C matches the registered pattern 81.

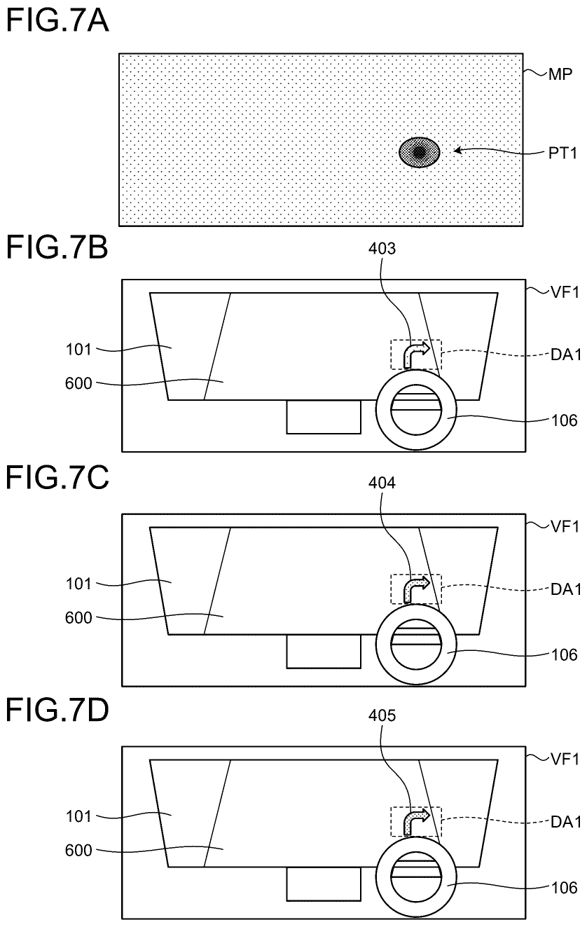

As a second modification of the first embodiment, display control as illustrated in FIGS. 7A to 7D may be performed. FIGS. 7A to 7D are diagrams illustrating a display control method according to the second modification of the first embodiment.

For example, let us assume that an attention state pattern as illustrated by the image IM2 in FIG. 6B and map information MP in FIG. 7A is included in the registered pattern 81 in advance.

In S1 of FIG. 5, the imaging range VF2 is captured, and an image IM1 as illustrated in FIG. 6A is acquired. The image IM1 illustrates a situation where there is no object on the road surface 600 for a certain period of time.

In S2 of FIG. 5, the display object 401 is added at the brightness BR1 to the display area DA1 in the image IM1, whereby the image IM2 as illustrated in FIG. 6B is generated.

In S3 of FIG. 5, the attention estimation model 7 is applied to the image IM2, the attention state of the driver 200 is estimated, and the map information MP as illustrated in FIG. 7A is generated. The map information MP is similar to the map information MP in FIG. 6C.

In S5 of FIG. 5, it is determined that the attention state pattern specified by the image IM2 of FIG. 6B and the map information MP of FIG. 7A matches the registered pattern 81.

In S7 of FIG. 5, the brightness of the display object 400 is determined to gradually increase from the brightness BR2 which is lower than the brightness BR1. The display 18 is controlled to gradually increase the brightness from the brightness BR2. The display 18 sequentially displays, in the display area DA1, a display object 403 at the brightness BR2 illustrated in FIG. 7B, a display object 404 at brightness BR3 (>BR2 and <BR1) illustrated in FIG. 7C, and a display object 405 at brightness BR4 (>BR3 and <BR1) illustrated in FIG. 7D.

Also with such display control, in such a case where displaying the display object 400 at the brightness BR1 results in excessive attention focused on the display object 400 in the field of view VF1, the display object 400 can be displayed in the display area DA1 at a brightness gradually increasing from the brightness BR2 at which the attention is suppressed as compared with the brightness BR1. As a result, the degree of concentration of attention on the display object 400 in the field of view VF1 can be kept within an allowable range.

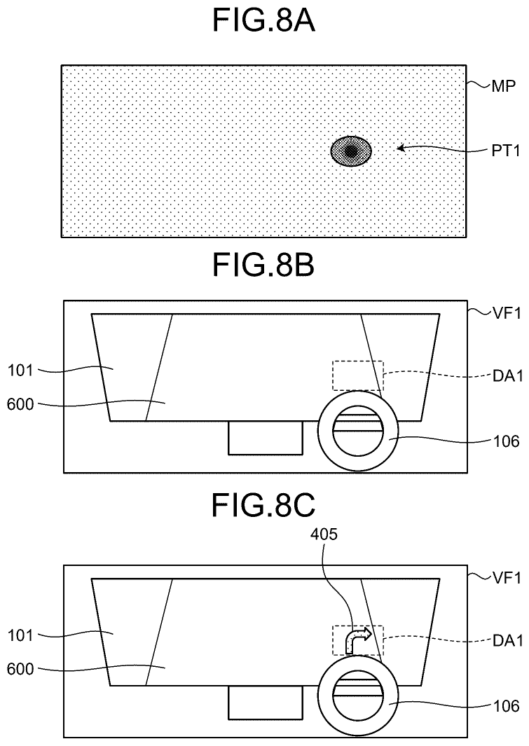

As a third modification of the first embodiment, display control as illustrated in FIGS. 8A to 8C may be performed. FIGS. 8A to 8C are diagrams illustrating a display control method according to the third modification of the first embodiment.

For example, let us assume that an attention state pattern as illustrated by the image IM2 in FIG. 6B and map information MP in FIG. 8A is included in the registered pattern 81 in advance.

In S1 of FIG. 5, the imaging range VF2 is captured, and an image IM1 as illustrated in FIG. 6A is acquired. The image IM1 illustrates a situation where there is no object on the road surface 600 for a certain period of time.

In S2 of FIG. 5, the display object 401 is added to the display area DA1 in the image IM1, whereby the image IM2 as illustrated in FIG. 6B is generated.

In S3 of FIG. 5, the attention estimation model 7 is applied to the image IM2, the attention state of the driver 200 is estimated, and the map information MP as illustrated in FIG. 8A is generated. The map information MP is similar to the map information MP in FIG. 6C.

In S5 of FIG. 5, it is determined that the attention state pattern specified by the image IM2 of FIG. 6B and the map information MP of FIG. 8A matches the registered pattern 81.

The timing at which the display object 400 starts to be displayed in S7 of FIG. 5 is modified from timing immediately after to timing delayed by time Δt. The display 18 is controlled to be delayed by time Δt. The display 18 does not display any display object in the display area DA1 during the time Δt as illustrated in FIG. 8B but displays the display object 405 in the display area DA1 as illustrated in FIG. 8C at the timing delayed by the time Δt.

Also with such display control, in such a case where displaying the display object 400 immediately results in excessive attention focused on the display object 400 in the field of view VF1, the display object 400 can be displayed in the display area DA1 at the timing delayed by the time Δt. As a result, the degree of concentration of attention on the display object 400 in the field of view VF1 can be kept within an allowable range.

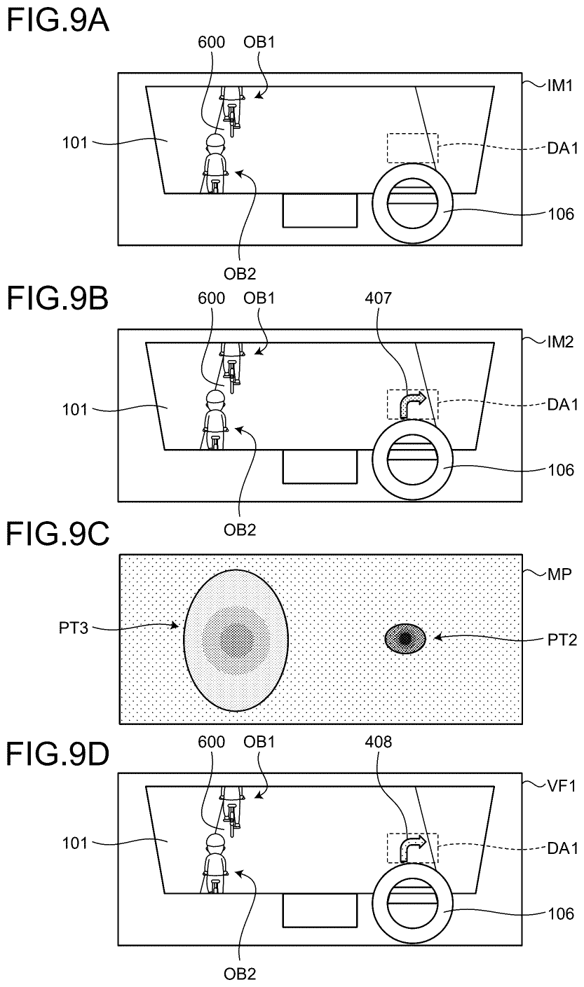

As a third modification of the first embodiment, display control as illustrated in FIGS. 9A to 9D may be performed. FIGS. 9A to 9D are diagrams illustrating the display control method according to the third modification of the first embodiment.

For example, let us assume that an attention state pattern as illustrated by an image IM2 in FIG. 9B and map information MP in FIG. 9C is included in the registered pattern 81 in advance.

In S1 of FIG. 5, the imaging range VF2 is captured, and an image IM1 as illustrated in FIG. 9A is acquired. The image IM1 illustrates a situation where objects OB1 and OB2 to be noted are present at positions away from the display area DA1 on the road surface 600.

In S2 of FIG. 5, a display object 407 is added at the brightness BR1 to the display area DA1 in the image IM1, whereby the image IM2 as illustrated in FIG. 9B is generated.

In S3 of FIG. 5, the attention estimation model 7 is applied to the image IM2, the attention state of the driver 200 is estimated, and the map information MP as illustrated in FIG. 9C is generated. The map information MP corresponds to the image IM2. In the map information MP, by referring to the image IM2, it is indicated that a pattern PT2, whose novelty level is greater than or equal to a threshold level Lth1, is included at a position corresponding to the display area DA1. The threshold level Lth1 can be experimentally determined in advance as a novelty level corresponding to excessive concentration of attention. In the map information MP, by referring to the image IM2, it is indicated that a pattern PT3, whose novelty level is greater than or equal to a threshold level Lth2, is included at a position away from the display area DA1. The threshold level Lth2 can be experimentally determined in advance as a novelty level corresponding to the need for attention.

In S5 of FIG. 5, it is determined that the attention state pattern specified by the image IM2 of FIG. 6B and the map information MP of FIG. 6C matches the registered pattern 81.

In S7 of FIG. 5, the brightness of the display object 400 is changed to the brightness BR2 which is lower than the brightness BR1. The display 18 is controlled at the brightness BR2, and the display 18 displays a display object 408 at the brightness BR2 in the display area DA1 in the field of view VF1 as illustrated in FIG. 9D.

Also with such display control, in such a case where displaying the display object 400 at the brightness BR1 results in excessive attention focused on the display object 400 in the field of view VF1, the display object 400 can be displayed in the display area DA1 at the brightness BR2 at which the attention is suppressed as compared with the brightness BR1. As a result, the degree of concentration of attention on the display object 400 in the field of view VF1 can be kept within an allowable range, and attention can be appropriately paid to the objects OB1 and OB2 to be noted.

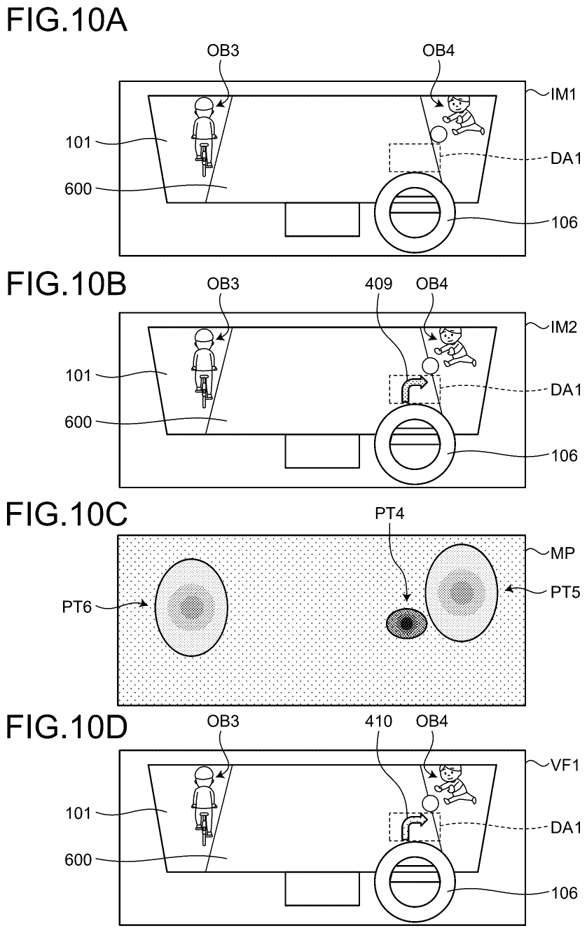

As a fourth modification of the first embodiment, display control as illustrated in FIGS. 10A to 10D may be performed. FIGS. 10A to 10D are diagrams illustrating a display control method according to the fourth modification of the first embodiment.

For example, let us assume that an attention state pattern as illustrated by an image IM2 in FIG. 10B and map information MP in FIG. 10C is included in the registered pattern 81 in advance.

In S1 of FIG. 5, the imaging range VF2 is captured, and an image IM1 as illustrated in FIG. 10A is acquired. The image IM1 illustrates a situation where objects OB3 and OB4 to be noted are present at a position away from the display area DA and a position close to the display area DA, respectively, on the road surface 600.

In S2 of FIG. 5, a display object 409 is added at the brightness BR1 to the display area DA1 in the image IM1, whereby the image IM2 as illustrated in FIG. 10B is generated.

In S3 of FIG. 5, the attention estimation model 7 is applied to the image IM2, the attention state of the driver 200 is estimated, and the map information MP as illustrated in FIG. 10C is generated. The map information MP corresponds to the image IM2. In the map information MP, by referring to the image IM2, it is indicated that a pattern PT2, whose novelty level is greater than or equal to a threshold level Lth1, is included at a position corresponding to the display area DA1. The threshold level Lth1 can be experimentally determined in advance as a novelty level corresponding to excessive concentration of attention. Furthermore, in the map information MP, by referring to the image IM2, it is indicated that patterns PT5 and PT6, whose novelty levels are greater than or equal to a threshold level Lth2, are included at a position close to and a position away from the display area DA1, respectively. The threshold level Lth2 can be experimentally determined in advance as a novelty level corresponding to the need for attention.

In S5 of FIG. 5, it is determined that the attention state pattern specified by the image IM2 of FIG. 10B and the map information MP of FIG. 10C matches the registered pattern 81.

In S7 of FIG. 5, the brightness of the display object 400 is changed to the brightness BR2 which is lower than the brightness BR1. The display 18 is controlled at the brightness BR2, and the display 18 displays a display object 410 at the brightness BR2 in the display area DA1 in the field of view VF1 as illustrated in FIG. 10D.

Also with such display control, in such a case where displaying the display object 400 at the brightness BR1 results in excessive attention focused on the display object 400 in the field of view VF1, the display object 400 can be displayed in the display area DA1 at the brightness BR2 at which the attention is suppressed as compared with the brightness BR1. As a result, the degree of concentration of attention on the display object 400 in the field of view VF1 can be kept within an allowable range, and attention can be appropriately paid to the objects OB3 and OB4 to be noted.

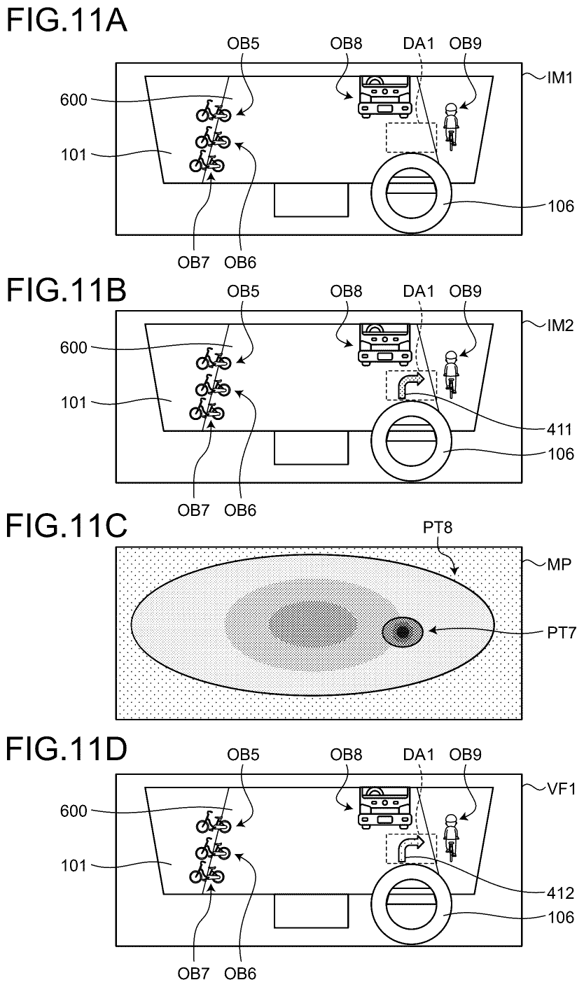

As a fifth modification of the first embodiment, display control as illustrated in FIGS. 11A to 11D may be performed. FIGS. 11A to 11D are diagrams illustrating a display control method according to the fifth modification of the first embodiment.

For example, let us assume that an attention state pattern as illustrated by an image IM2 in FIG. 11B and map information MP in FIG. 11C is included in the registered pattern 81 in advance.

In S1 of FIG. 5, the imaging range VF2 is captured, and an image IM1 as illustrated in FIG. 11A is acquired. The image IM1 illustrates a situation in which objects OB5 to OB9 to be noted are present over the entire road surface 600.

In S2 of FIG. 5, a display object 411 is added at the brightness BR1 to the display area DA1 in the image IM1, whereby the image IM2 as illustrated in FIG. 11B is generated.

In S3 of FIG. 5, the attention estimation model 7 is applied to the image IM2, the attention state of the driver 200 is estimated, and the map information MP as illustrated in FIG. 11C is generated. The map information MP corresponds to the image IM2. In the map information MP, by referring to the image IM2, it is indicated that a pattern PT2, whose novelty level is greater than or equal to a threshold level Lth1, is included at a position corresponding to the display area DA1. The threshold level Lth1 can be experimentally determined in advance as a novelty level corresponding to excessive concentration of attention. In the map information MP, by referring to the image IM2, it is indicated that a pattern PT8, whose novelty level is greater than or equal to a threshold level Lth2, is included over a wide range including the display area DA1. The threshold level Lth2 can be experimentally determined in advance as a novelty level corresponding to the need for attention.

In S5 of FIG. 5, it is determined that the attention state pattern specified by the image IM2 of FIG. 11B and the map information MP of FIG. 11C matches the registered pattern 81.

In S7 of FIG. 5, the brightness of the display object 400 is changed to the brightness BR2 which is lower than the brightness BR1. The display 18 is controlled at the brightness BR2, and the display 18 displays a display object 412 at the brightness BR2 in the display area DA1 in the field of view VF1 as illustrated in FIG. 11D.

Also with such display control, in such a case where displaying the display object 400 at the brightness BR1 results in excessive attention focused on the display object 400 in the field of view VF1, the display object 400 can be displayed in the display area DA1 at the brightness BR2 at which the attention is suppressed as compared with the brightness BR1. As a result, the degree of concentration of attention on the display object 400 in the field of view VF1 can be kept within an allowable range, and attention can be appropriately paid to the objects OB5 and OB9 to be noted.

As a sixth modification of the first embodiment, display control may be performed on a plurality of displays including the display 18. For example, in addition to the display 18, the display control system 2 may include the displays 21 to 23 indicated by dotted lines in FIGS. 3 and 4. Display areas DA2 and DA3 of the displays 21 and 22 may be provided on the pillars 108 that support the roof portion 107 of the vehicle body 100a illustrated in FIG. 2 on both sides in the Y direction of the windshield 101. A display area DA4 of the display 23 is further provided on the −Z side of the windshield 101.

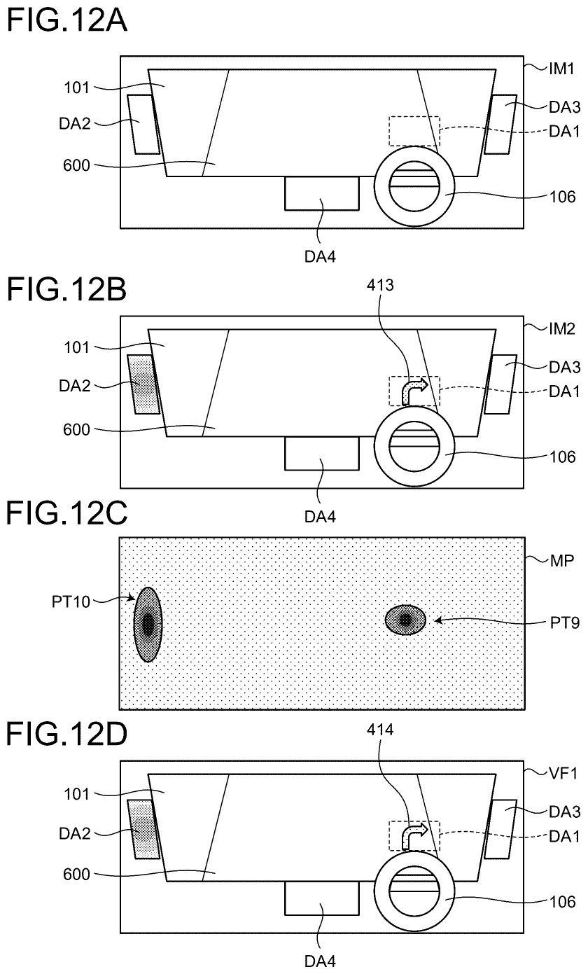

In this case, display control as illustrated in FIGS. 12A to 12D may be performed. FIGS. 12A to 12D are diagrams illustrating a display control method according to the sixth modification of the first embodiment.

For example, let us assume that an attention state pattern as illustrated by an image IM2 in FIG. 12B and map information MP in FIG. 12C is included in the registered pattern 81 in advance.

In S1 of FIG. 5, the imaging range VF2 is captured, and an image IM1 as illustrated in FIG. 12A is acquired. The image IM1 illustrates a situation where there is no object on the road surface 600 for a certain period of time.

In S2 of FIG. 5, a display object 401 is added at the brightness BR1 to the display area DA1 in the image IM1, and a display object is added at the brightness BR11 to the display area DA2, whereby the image IM2 as illustrated in FIG. 12B is generated.

In S3 of FIG. 5, the attention estimation model 7 is applied to the image IM2, the attention state of the driver 200 is estimated, and the map information MP as illustrated in FIG. 12C is generated. The map information MP corresponds to the image IM2. In the map information MP, by referring to the image IM2, it is indicated that patterns PT9 and PT10, whose novelty level is greater than or equal to a threshold level Lth1, are included at positions corresponding to the plurality of display areas DA1 and DA2, respectively. The threshold level Lth1 can be experimentally determined in advance as a novelty level corresponding to excessive concentration of attention.

In S5 of FIG. 5, it is determined that the attention state pattern specified by the image IM2 of FIG. 12B and the map information MP of FIG. 12C matches the registered pattern 81.

In S7 of FIG. 5, the brightness of the display object 400 in the display area DA1 is changed to the brightness BR2 which is lower than the brightness BR1, and the brightness of the display object in the display area DA2 is changed to the brightness BR12 which is lower than the brightness BR11. The displays 18 and 21 are controlled at the brightness BR2 and BR12, respectively, and as illustrated in FIG. 6D, the display 18 displays the display object 402 in the display area DA1 in the field of view VF1 at the brightness BR2, and the display 21 displays a display object in the display area DA2 with the brightness BR12.

Also with such display control, in such a case where displaying the display objects of the plurality of display areas DA1 and DA2 at the brightness BR1 and BR11 results in excessive attention focused on the plurality of display objects in the field of view VF1, the display objects of the display areas DA1 and DA2 can be displayed in the display areas DA1 and DA12 at the brightness BR2 and BR12 at which the attention is suppressed as compared with the brightness BR1 and BR11. As a result, the degree of concentration of attention on each of the plurality of display objects in the field of view VF1 can be kept within an allowable range.

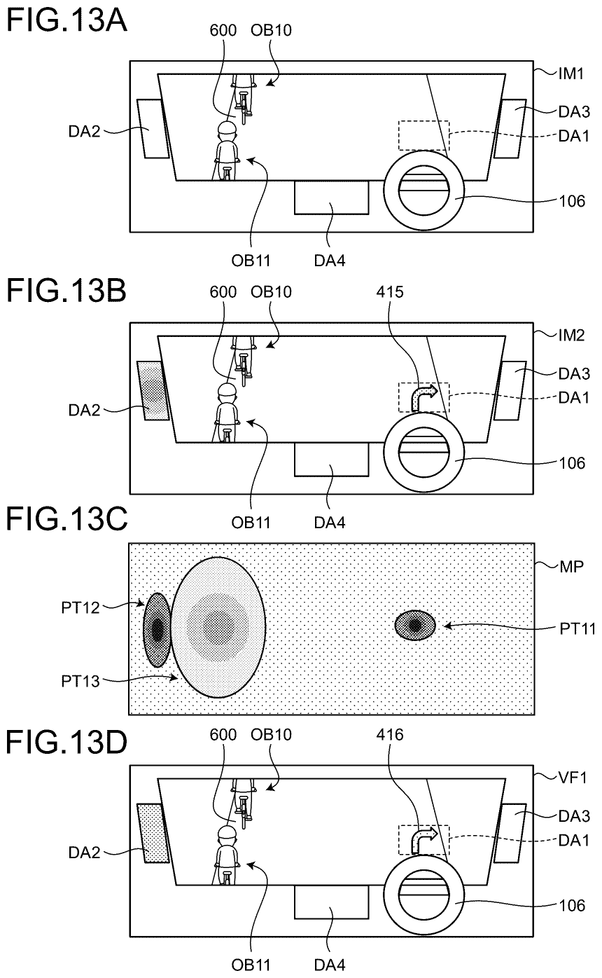

As a seventh modification of the first embodiment, display control as illustrated in FIGS. 13A to 13D may be performed. FIGS. 13A to 13D are diagrams illustrating a display control method according to the seventh modification of the first embodiment.

For example, let us assume that an attention state pattern as illustrated by an image IM2 in FIG. 13B and map information MP in FIG. 13C is included in the registered pattern 81 in advance.

In S1 of FIG. 5, the imaging range VF2 is captured, and an image IM1 as illustrated in FIG. 13A is acquired. The image IM1 illustrates a situation where objects OB10 and OB11 to be noted are present between the display areas DA1 and DA2 on the road surface 600.

In S2 of FIG. 5, a display object 415 is added at the brightness BR1 to the display area DA1 in the image IM1, and a display object is added at the brightness BR11 to the display area DA2, whereby the image IM2 as illustrated in FIG. 13B is generated.

In S3 of FIG. 5, the attention estimation model 7 is applied to the image IM2, the attention state of the driver 200 is estimated, and the map information MP as illustrated in FIG. 13C is generated. The map information MP corresponds to the image IM2. In the map information MP, by referring to the image IM2, it is indicated that patterns PT11 and PT12, whose novelty levels are greater than or equal to a threshold level Lth1, are included at positions corresponding to the display areas DA1 and DA2. The threshold level Lth1 can be experimentally determined in advance as a novelty level corresponding to excessive concentration of attention. In the map information MP, by referring to the image IM2, it is indicated that a pattern PT13, whose novelty level is greater than or equal to a threshold level Lth2, is included between the display areas DA1 and DA2. The threshold level Lth2 can be experimentally determined in advance as a novelty level corresponding to the need for attention.

In S5 of FIG. 5, it is determined that the attention state pattern specified by the image IM2 of FIG. 13B and the map information MP of FIG. 13C matches the registered pattern 81.

In S7 of FIG. 5, the brightness of the display object in the display area DA1 is changed to the brightness BR2 which is lower than the brightness BR1, and the brightness of the display object in the display area DA2 is changed to the brightness BR12 which is lower than the brightness BR11. The displays 18 and 21 are controlled at the brightness BR2 and BR12, respectively, and as illustrated in FIG. 13D, the display 18 displays a display object 416 in the display area DA1 in the field of view VF1 at the brightness BR2, and the display 21 displays the display object in the display area DA2 at the brightness BR12.

Also with such display control, in such a case where displaying the display objects of the plurality of display areas DA1 and DA2 at the brightness BR1 and BR11 results in excessive attention focused on the plurality of display objects in the field of view VF1, the display objects of the display areas DA1 and DA2 can be displayed in the display areas DA1 and DA12 at the brightness BR2 and BR12 at which the attention is suppressed as compared with the brightness BR1 and BR11. As a result, the degree of concentration of attention on each of the plurality of display objects in the field of view VF1 can be kept within an allowable range, and attention can be appropriately paid to the objects OB10 and OB11 to be noted.

### Second Embodiment

Next, a display control method according to a second embodiment will be described. Hereinafter, parts different from the first embodiment will be mainly described.

In the first embodiment, examples in which the display form of a display object is changed depending on an estimation result of the attention state are described; however, in the second embodiment, examples of evaluation for determining the display form to be changed to are described. For example, in a case where the driver needs to pay attention to an object (for example, a pedestrian) in the actual view of the forward field of view to be looked at, it is objectively evaluated whether or not the display object to be displayed on a display affects the attention state of the driver.

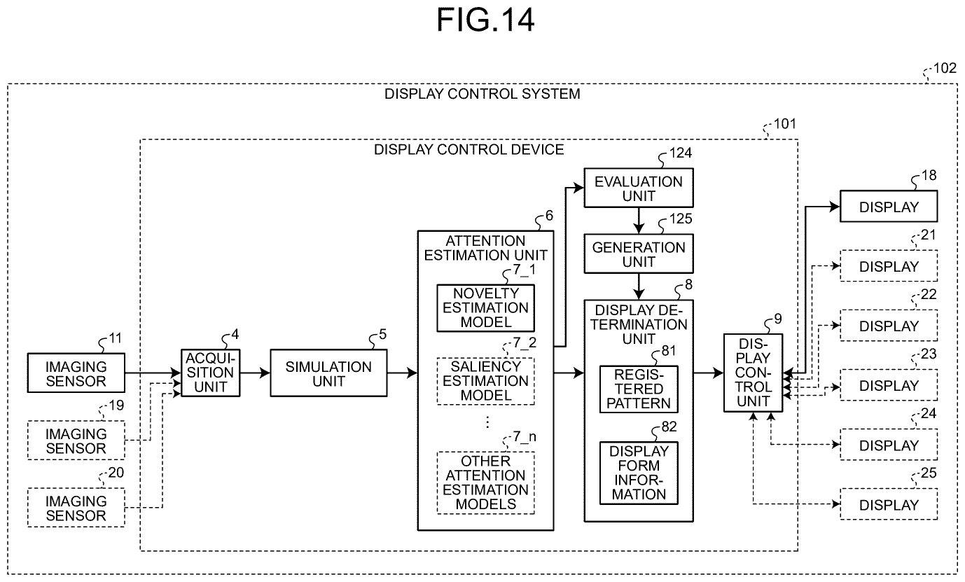

As illustrated in FIG. 14, a display control device 101 of a display control system 102 further includes an evaluation unit 124 and a generation unit 125 with respect to the display control device 1 (see FIG. 4). FIG. 14 is a diagram illustrating a functional configuration of the display control device 101.

In the display control system 102, units of the display control device 101 illustrated in FIG. 14 may be implemented hardware-wise (for example, as circuits), may be implemented software-wise, or may be partially implemented hardware-wise with the remainder implemented software-wise. In the case where the units illustrated in FIG. 14 are implemented software-wise, the CPU 13 (see FIG. 3) may execute the program 17 to functionally configure the units illustrated in FIG. 14 on the volatile storage unit 14 collectively at the time of compilation or sequentially as the processing progresses.

The display control device 101 operates similarly to the first embodiment after shipment but performs evaluation for determining the display form before the shipment.

For example, in the display control device 101, a simulation unit 5 supplies images IM1 and IM2 to an attention estimation unit 6. The attention estimation unit 6 estimates the attention state of a driver 200 by applying one or more attention estimation models 7 to each of the images IM1 and IM2.

In a case where the attention estimation model 7 is a novelty estimation model 7_1, the attention estimation unit 6 inputs visual field images at a plurality of time points in the past and the image IM1 to the novelty estimation model 7_1. The novelty estimation model 7_1 generates the current prediction image from the visual field images at the plurality of time points in the past, two-dimensionally obtains the prediction error related to human cognition on the basis of the image IM1 and the prediction image, and generates map information MP1 indicating a distribution of the two-dimensional prediction errors. The novelty estimation model 7_1 outputs the map information MP1 to the attention estimation unit 6. The attention estimation unit 6 supplies an estimation result of the attention state including the image IM1 and the map information MP1 to the evaluation unit 124 as an estimation result of the attention state with respect to the image IM1.

Similarly, the attention estimation unit 6 inputs the visual field images at the plurality of time points in the past and the image IM2 to the novelty estimation model 7_1. The novelty estimation model 7_1 generates the current prediction image from the visual field images at the plurality of time points in the past, two-dimensionally obtains the prediction error related to human cognition on the basis of the image IM2 and the prediction image, and generates map information MP2 indicating a distribution of the two-dimensional prediction errors. The novelty estimation model 7_1 outputs the map information MP2 to the attention estimation unit 6. The attention estimation unit 6 supplies an estimation result of the attention state including the image IM2 and the map information MP2 to a display determination unit 8 as an estimation result of the attention state with respect to the image IM2.

The evaluation unit 124 evaluates the influence of a display object 400 on the attention state with respect to the image IM1 depending on the estimation result of the attention state with respect to the image IM1 and the estimation result of the attention state with respect to the image IM2. The evaluation unit 124 convolutionally integrates values in the map information MP1 with respect to a region near an object to be noted and a region near the display object 400. The evaluation unit 124 convolutionally integrates values in the map information MP2 with respect to a region near an object to be noted and a region near the display object 400. The evaluation unit 124 may calculate the degree of influence of the display object 400 on the image IM1 by dividing the difference between the integrated value of the map information MP1 and the integrated value of the map information MP2 by the maximum integrated value in the map information MP1. The evaluation unit 124 supplies the evaluation result to the generation unit 125. The evaluation result may include an attention state pattern corresponding to the display object 400, the display form of the display object 400, and the degree of influence by the display form.

The generation unit 125 determines the display form and generates display form information 82 depending on the evaluation result. The generation unit 125 may generate the display form information 82 to include the display form of the display object 400 included in the evaluation result in association with the attention state pattern included in the evaluation result if as the degree of influence included in the evaluation result is within an allowable range. Alternatively, the generation unit 125 may generate the display form information 82 so as to include the display form of the display object 400 included in the evaluation result in association with the attention state pattern included in the evaluation result when receiving an instruction to employ the display object and the display form corresponding to the evaluation result. As a result, the generation unit 125 can generate display form information in such a manner as to include a display form DF2 in which attention is suppressed as compared with a display form DF1 of the image IM1.

The generation unit 125 supplies the display form information to the display determination unit 8. Accordingly, the display determination unit 8 may generate the display form information 82. Alternatively, if the display form information 82 is already obtained, the display determination unit 8 updates the display form information 82 with the supplied display form information. For example, the display determination unit 8 may update the display form information 82 by adding the supplied display form information to the display form information 82.

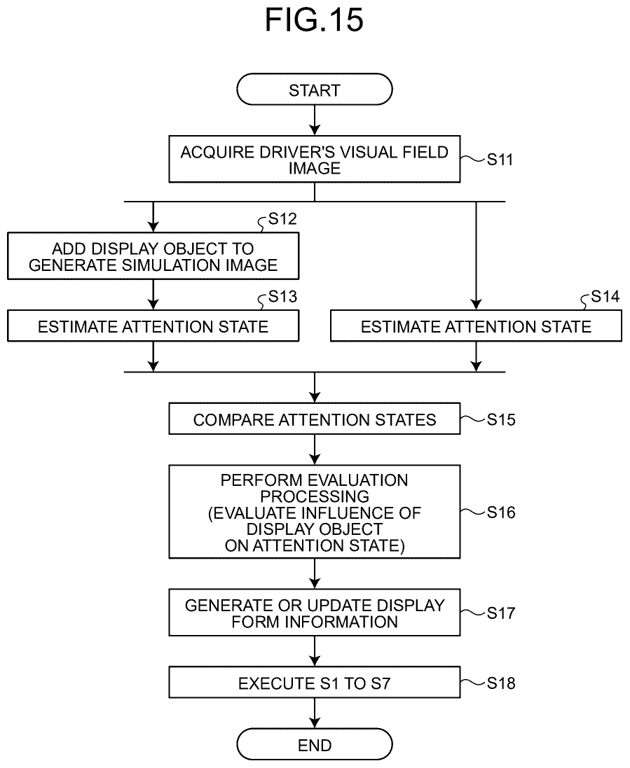

Meanwhile, as illustrated in FIG. 15, the display control method executed by the display control system 102 is different from the first embodiment in the following points. FIG. 15 is a flowchart illustrating a display control method according to the second embodiment.

In the display control system 102, the display control device 101 acquires the image IM1, in which an imaging range VF2 is captured by an imaging sensor 11, from the imaging sensor 11 as a visual field image (S11).

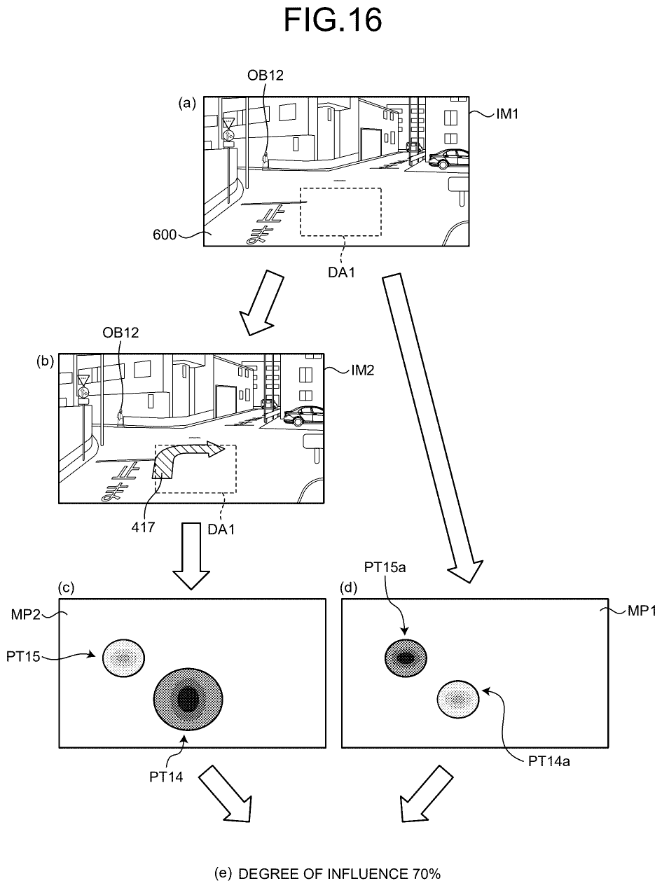

For example, the imaging range VF2 is captured, and an image IM1 as illustrated at (a) in FIG. 16 is acquired. FIG. 16 is a diagram illustrating the display control method according to the second embodiment. The image IM1 illustrates a situation where an object OB13 to be noted is present at a position away from a display area DA1 on a road surface 600. FIG. 16 illustrates, at (a), a portion near the display area DA1 in the image IM1 for the sake of simplicity.

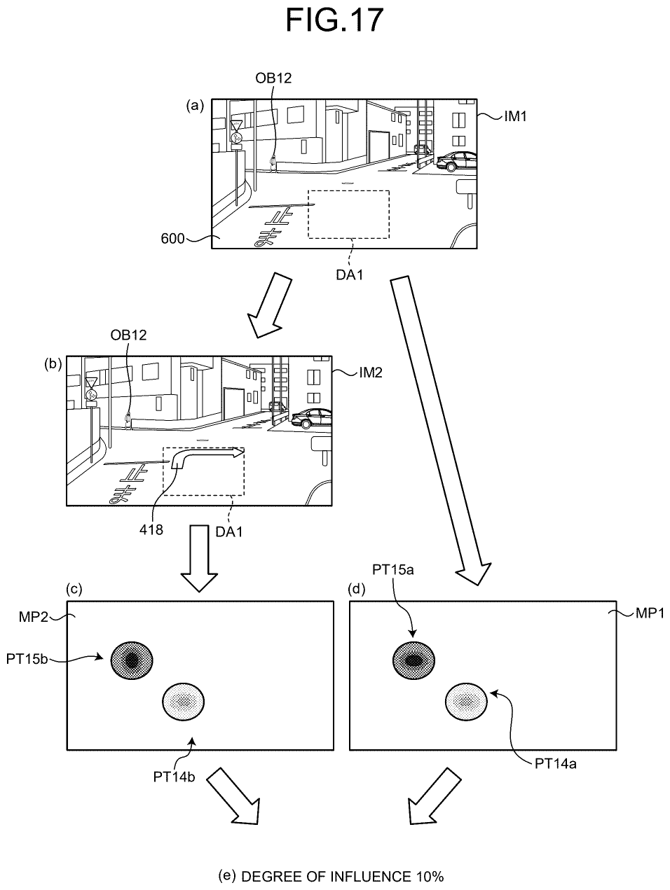

Alternatively, the imaging range VF2 is captured, and an image IM1 as illustrated at (a) in FIG. 17 is acquired. FIG. 17 is a diagram illustrating the display control method according to the second embodiment. The image IM1 illustrates a situation where an object OB13 to be noted is present at a position away from a display area DA1 on a road surface 600. FIG. 17 illustrates, at (a), a portion near the display area DA1 in the image IM1 for the sake of simplicity.

After S11, processing of S12 to S13 and processing of S14 are performed in parallel.

In the processing of S12 to S13, the display control device 101 generates the image IM2 as a simulation image by adding the display object 400 to the display area DA1 in the image IM1 in the display form DF1 (S2).

For example, a display object 417 is added at the brightness BR1 to the display area DA1 in the image IM1, whereby an image IM2 as illustrated at (b) in FIG. 16 is generated. FIG. 16(b) illustrates a portion near the display area DA1 in the image IM2 for the sake of simplicity.

Alternatively, a display object 418 is added at the brightness BR2 to the display area DA1 in the image IM1, whereby an image IM2 as illustrated at (b) in FIG. 17 is generated. FIG. 17 illustrates, at (b), a portion near the display area DA1 in the image IM2 for the sake of simplicity.

The display control device 101 applies the attention estimation model 7 to the image IM2 to estimate the attention state of the driver 200 (S3) and generates an estimation result of the attention state with respect to the image IM2.

For example, the attention estimation model 7 is applied to the image IM2 at (b) in FIG. 16, the attention state of the driver 200 is estimated, and map information MP2 as illustrated at (c) in FIG. 16 is generated. The map information MP2 corresponds to the image IM2. In the map information MP2, by referring to the image IM2, it is indicated that a pattern PT14, whose novelty level is greater than or equal to a threshold level Lth1, is included at a position corresponding to the display area DA1. The threshold level Lth1 can be experimentally determined in advance as a novelty level corresponding to excessive concentration of attention. In the map information MP2, by referring to the image IM2, it is indicated that a pattern PT15, whose novelty level is greater than or equal to a threshold level Lth2, is included at a position away from the display area DA1. The threshold level Lth2 can be experimentally determined in advance as a novelty level corresponding to the need for attention.

Alternatively, the attention estimation model 7 is applied to the image IM2 at (b) in FIG. 17, the attention state of the driver 200 is estimated, and map information MP2 as illustrated at (c) in FIG. 17 is generated. The map information MP2 corresponds to the image IM2. In the map information MP2, by referring to the image IM2, it is indicated that a pattern PT14b, whose novelty level is greater than or equal to a threshold level Lth2, is included at a position corresponding to the display area DA1. The threshold level Lth2 can be experimentally determined in advance as a novelty level corresponding to the need for attention. In the map information MP2, by referring to the image IM2, it is indicated that a pattern PT15b, whose novelty level is greater than or equal to a threshold level Lth1, is included at a position away from the display area DA1. The threshold level Lth1 can be experimentally determined in advance as a novelty level corresponding to excessive concentration of attention.

Meanwhile, in processing of S14, the display control device 101 applies the attention estimation model 7 to the image IM1, estimates the attention state of the driver 200, and generates an estimation result of the attention state with respect to the image IM1.

For example, the attention estimation model 7 is applied to the image IM1 at (a) in FIG. 16, the attention state of the driver 200 is estimated, and the map information MP1 as illustrated at (d) in FIG. 16 is generated. The map information MP1 corresponds to the image IM1. In the map information MP1, by referring to the image IM1, it is indicated that a pattern PT14a, whose novelty level is greater than or equal to a threshold level Lth2, is included at a position corresponding to the display area DA1. The threshold level Lth1 can be experimentally determined in advance as a novelty level corresponding to excessive concentration of attention. In the map information MP1, by referring to the image IM1, it is indicated that a pattern PT15a, whose novelty level is greater than or equal to a threshold level Lth2, is included at a position away from the display area DA1. The threshold level Lth2 can be experimentally determined in advance as a novelty level corresponding to the need for attention.

Alternatively, the attention estimation model 7 is applied to the image IM1 at (a) in FIG. 17, the attention state of the driver 200 is estimated, and the map information MP1 as illustrated at (d) in FIG. 17 is generated. The map information MP1 corresponds to the image IM1. In the map information MP1, by referring to the image IM1, it is indicated that the pattern PT14a, whose novelty level is greater than or equal to the threshold level Lth2, is included at a position corresponding to the display area DA1. The threshold level Lth1 can be experimentally determined in advance as a novelty level corresponding to excessive concentration of attention. In the map information MP1, by referring to the image IM1, it is indicated that a pattern PT15a, whose novelty level is greater than or equal to a threshold level Lth2, is included at a position away from the display area DA1. The threshold level Lth2 can be experimentally determined in advance as a novelty level corresponding to the need for attention.

When both the processing of S12 to S13 and the processing of S14 are completed, the display control device 101 evaluates the influence of the display object 400 on the attention state with respect to the image IM1 depending on the estimation result of the attention state with respect to the image IM1 and the estimation result of the attention state with respect to the image IM2.

That is, the display control device 101 compares the estimation result of the attention state obtained in S11 with the estimation result of the attention state obtained in S3 (S15) and performs evaluation processing depending on the comparison result (S16).

In the evaluation processing (S16), the display control device 101 evaluates the influence of the display object 400 on the attention state depending on the comparison result. The display control device 101 convolutionally integrates values in the map information MP1 with respect to a region near an object to be noted and a region near the display object 400. The display control device 101 convolutionally integrates values in the map information MP2 with respect to a region near an object to be noted and a region near the display object 400. The display control device 101 may calculate the degree of influence of the display object 400 on the image IM1 by dividing the difference between the integrated value of the map information MP1 and the integrated value of the map information MP2 by the maximum integrated value in the map information MP1.

For example, values in the map information MP2 illustrated at (c) in FIG. 16 are convolutionally integrated with respect to a region near the object OB12 and a region near the display object 417. Values in the map information MP2 are convolutionally integrated with respect to the region near the object OB12 and the region near the display object 417. The difference between the integrated value of the map information MP1 and the integrated value of the map information MP2 is divided by the maximum integrated value in the map information MP1, and as illustrated at (e) in FIG. 16, the degree of influence of the display object 400 on the image IM1 is calculated. At (e) in FIG. 16, as the evaluation result, a degree of influence of 70% is illustrated as an example.

FIG. 16 is an example in which, in the absence of the display object 417, the pattern PT15a whose novelty level is greater than or equal to the threshold level Lth2 corresponds to a walking pedestrian, and the pattern PT14a whose novelty level is greater than or equal to the threshold level Lth2 corresponds to a road sign of “stop”. In FIG. 16, in a case where the display object 417 is displayed superimposed on the actual view of the forward field of view, the fact that the pattern PT15 whose novelty level is greater than or equal to the threshold level Lth2 is displayed in a lighter tone than the pattern PT15a whose novelty level is greater than or equal to the threshold level Lth2 indicates a reduced degree of influence of attracting attention to the region of the pattern PT15a whose novelty level is greater than or equal to the threshold level Lth2 that corresponds to the walking pedestrian. Moreover, the fact that the pattern PT14, having the novelty level greater than or equal to the threshold level Lth1, has an area larger than that of the pattern PT14a, having the novelty level greater than or equal to the threshold level Lth2, and is displayed in a deeper tone indicates an extremely increased degree of influence of attracting attention to the region of the pattern PT14a having the novelty level greater than or equal to the threshold level Lth2 that corresponds to the road sign.

For this reason, in a situation where attention should be paid to a pedestrian rather than to a road sign, attention to the pedestrian is less likely to be paid as compared to a case where the display object 417 is not displayed, and attention to the road sign that does not require as much attention as that to the pedestrian is more likely to be paid (since road signs can be proactively viewed by the driver due to the knowledge of traffic rules, whereas paying attention to all the pedestrians walking around is difficult) as compared to a case where the display object 417 is not displayed. In a case where the degree of influence of the display object 417 on the pedestrians is 45% on the basis of the statistical distribution and the degree of influence on the road signs is 25% on the basis of the statistical distribution, it can be deemed that the degree of influence of the display object 417 totals 70%. Alternatively, without separating targets such as pedestrians or road signs, comparison may be made between the sum of products of the area and the color depth of the region of the pattern PT14a having a novelty level greater than or equal to the threshold level Lth2 and the area of the pattern PT15a having a novelty level greater than or equal to the threshold level Lth2 in the case where the display object 417 is not displayed and the sum of products of the area and the color depth of the region of the pattern PT14 having a novelty level greater than or equal to the threshold level Lth1 and the area of the pattern PT15 having a novelty level greater than or equal to the threshold level Lth2 in the case where the display object 417 is displayed. Technology for separating targets in this case may be known technology as scene segmentation technology.

Alternatively, values in the map information MP2 illustrated at (c) in FIG. 17 are convolutionally integrated with respect to a region near the object OB12 and a region near the display object 417. Values in the map information MP2 are convolutionally integrated with respect to the region near the object OB12 and the region near the display object 417. The difference between the integrated value of the map information MP1 and the integrated value of the map information MP2 is divided by the maximum integrated value in the map information MP1, and as illustrated at (e) in FIG. 17, the degree of influence of the display object 400 on the image IM1 is calculated. At (e) in FIG. 17(e), as the evaluation result, a degree of influence of 10% is illustrated as an example.

FIG. 17 is an example in which, in the absence of the display object 418, the pattern PT15a whose novelty level is greater than or equal to the threshold level Lth2 corresponds to a walking pedestrian, and the pattern PT14a whose novelty level is greater than or equal to the threshold level Lth2 corresponds to a road sign of “stop”. In FIG. 17, in a case where the display object 418 is displayed superimposed on the actual view of the forward field of view, the fact that the pattern PT15b having a novelty level greater than or equal to the threshold level Lth1 is displayed with an area and a tone of color that are almost the same as those of the pattern PT15a having a novelty level greater than or equal to the threshold level Lth2 indicates that the novelty level corresponding to the walking pedestrian does not affect the degree of influence of attracting attention to the region of the pattern PT15a having the novelty level greater than or equal to the threshold level Lth2. Moreover, the fact that the pattern PT14b, having the novelty level greater than or equal to the threshold level Lth2, is displayed in an area and a tone substantially the same as those of the pattern PT14a, having the novelty level greater than or equal to the threshold level Lth2, indicates substantially the same degree of influence of attracting attention to the region of the pattern PT14a having the novelty level greater than or equal to the threshold level Lth2 that corresponds to the road sign.

For this reason, in a situation where attention should be paid to a pedestrian rather than to a road sign, attention to the pedestrian is not different from that in the case where the display object 418 is not displayed, and attention to the road sign that does not require as much attention as that to the pedestrian is not different from that in the case where the display object 417 is not displayed. In a case where the degree of influence of the display object 418 on the pedestrians is 5% on the basis of the statistical distribution and the degree of influence on the road signs is 5% on the basis of the statistical distribution, it can be deemed that the degree of influence of the display object 418 totals 10%. Alternatively, without separating targets such as pedestrians or road signs, comparison may be made between the sum of products of the area and the color depth of the region of the pattern PT14a having a novelty level greater than or equal to the threshold level Lth2 and the area of the pattern PT15a having a novelty level greater than or equal to the threshold level Lth2 in the case where the display object 418 is not displayed and the sum of products of the area and the color depth of the region of the pattern PT14b having a novelty level greater than or equal to the threshold level Lth2 and the area of the pattern PT15b having a novelty level greater than or equal to the threshold level Lth1 in the case where the display object 418 is displayed. Technology for separating targets in this case may be known technology as scene segmentation technology.

As illustrated in the examples of FIGS. 16 and 17, it is possible to quantitatively evaluate that the display object 418 is superior to the display object 417 from the objective criteria through comparison of the degree of influence between the variations of the display object with respect to a video of the actual view in the forward field of view.

The display control device 101 determines the display form and generates or updates the display form information 82 depending on the evaluation result in S13 (S17).

In a case where the display form information 82 has not been generated, the display control device 101 may generate the display form information 82 if as the degree of influence included in the evaluation result is within an allowable range. The display control device 101 may generate the display form information 82 including the display form of the display object 400 included in the evaluation result in association with the attention state pattern included in the evaluation result.

For example, let us presume that the allowable range of the degree of influence is greater than or equal to 0% and less than 158. In a case where the evaluation result includes the “degree of influence of 70%” illustrated at (e) in FIG. 16, the display form (for example, brightness BR1) of the display object 417 is not employed as information to be included in the display form information 82 since the degree of influence included in the evaluation result is outside the allowable range.

Alternatively, in a case where the evaluation result includes the “degree of influence of 10%” illustrated at (e) in FIG. 17, the display form (for example, brightness BR2) of the display object 418 is employed as information to be included in the display form information 82 since the degree of influence included in the evaluation result is within the allowable range. The attention state pattern illustrated at (b) and (c) in FIG. 16 is added as the registered pattern 18. In addition, display form information 82 including the display form (for example, brightness BR2) of the display object 418 illustrated at (b) in FIG. 17(b) can be generated in association with the attention state pattern illustrated at (b) and (c) in FIG. 16.

In a case where the display form information 82 has been generated, the display control device 101 may update the display form information 82 if the degree of influence included in the evaluation result is within the allowable range. The display control device 101 may update the display form information 82 by adding the display form of the display object 400 included in the evaluation result in association with the attention state pattern included in the evaluation result.

For example, let us presume that the allowable range of the degree of influence is greater than or equal to 0% and less than 15%. In a case where the evaluation result includes the “degree of influence of 70%” illustrated at (e) in FIG. 16, the display form (for example, brightness BR1) of the display object 417 is not employed as information to be added to the display form information 82 since the degree of influence included in the evaluation result is outside the allowable range.

Alternatively, in a case where the evaluation result includes the “degree of influence of 10%” illustrated at (e) in FIG. 17, the display form (for example, brightness BR2) of the display object 418 is employed as information to be added to the display form information 82 since the degree of influence included in the evaluation result is within the allowable range. The attention state pattern illustrated at (b) and (c) in FIG. 16 is added as the registered pattern 18. In addition, the display form information 82 can be updated by adding the display form (for example, brightness BR2) of the display object 418 illustrated at (b) in FIG. 17 in association with the attention state pattern illustrated at (b) and (c) in FIG. 16.

Then, the display control device 101 performs the processing of S1 to S7 in FIG. 5 (S18).

For example, in a case where the attention state pattern matches the registered pattern 81 (Yes in S5), the display control device 101 refers to the display form information 82 generated or updated in S17 and determines the display form of the display object 400 to the display form DF2. The display form DF2 is a display form in which attention is suppressed as compared with the display form DF1 of the simulation image in S2. The display control device 101 controls the display 18 to display the display object 400 in the display area DA1 in the vehicle interior 110 in the display form DF2 (S7).

As described above, in the second embodiment, the display control method includes acquiring a visual field image, generating a simulation image from the visual field image, applying an attention estimation model to each of the simulation image and the visual field image, and evaluating an influence on the attention state by adding a display object in the display form DF2. As a result, in such a case where displaying the display object 400 in the display form DF1 results in excessive attention focused on the display object 400 in the field of view VF1, the display form of the display object 400 in which attention is suppressed as compared with the display form DF1 can be determined as the display form DF2 depending on the evaluation result of the display form DF2. As a result, the display form information 82 including the display form DF2, which has been determined, can be generated, and for example, in a case where the attention state pattern matches the registered pattern 81, the display form of the display object 400 can be changed from the display form DF1 of the simulation image to the display form DF2 in which attention is more suppressed, with reference to the display form information 82.

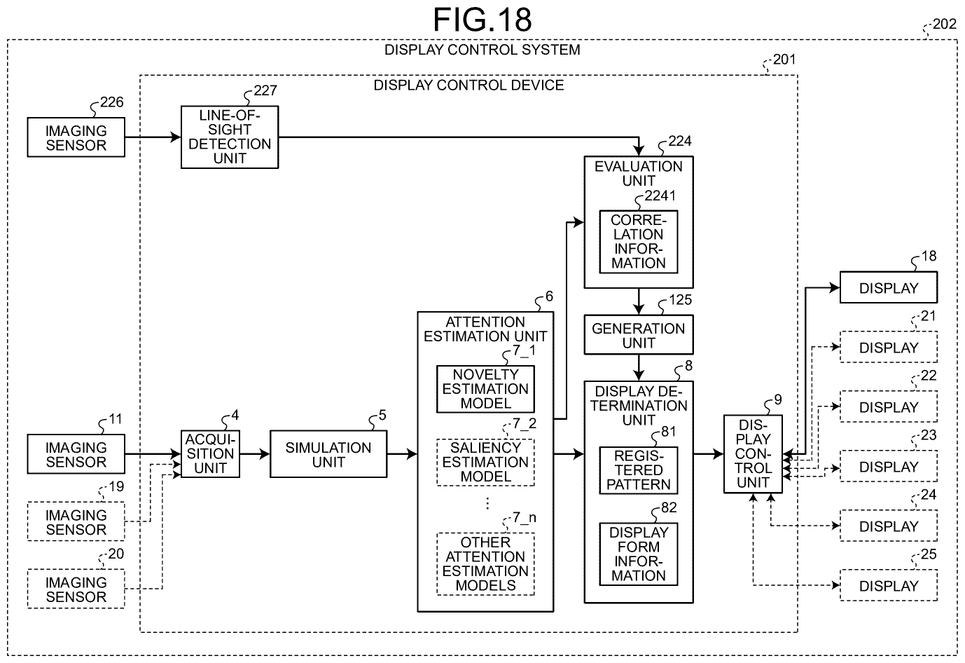

Note that, as a first modification of the second embodiment, evaluation for determining the display form may be performed in further consideration of correlation between the line of sight and the attention state of the driver. In this case, as illustrated in FIG. 18, a display control system 202 includes a display control device 201 instead of the display control device 101 (see FIG. 14) and further includes an imaging sensor 226. The display control device 201 further includes a line-of-sight detection unit 227. FIG. 18 is a diagram illustrating a functional configuration of the display control device 201 according to the first modification of the second embodiment.

The imaging sensor 226 has an imaging range VF12. The imaging range VF12 includes the pupils of the eyeballs of the driver 200. The imaging sensor 226 acquires an image of the pupils. The image of the pupils includes information about the direction of line of sight of the driver 200. The imaging sensor 226 supplies an image signal indicating the image of the pupils to the line-of-sight detection unit 227.

The line-of-sight detection unit 227 acquires the image signal from the imaging sensor 226. The line-of-sight detection unit 227 extracts line-of-sight information regarding the direction of the line of sight of the driver 200 from the image signal. The line-of-sight detection unit 227 supplies the line-of-sight information to an evaluation unit 224.

The evaluation unit 224 receives the line-of-sight information from the line-of-sight detection unit 227 and receives an estimation result of the attention state with respect to the image IM2 from an attention estimation unit 6. The evaluation unit 224 may generate correlation information 2241 indicating correlation between the line of sight of the driver and the attention state of the driver in accordance with the information about the direction of the line of sight of the driver 200 and the estimation result of the attention state with respect to the image IM2.

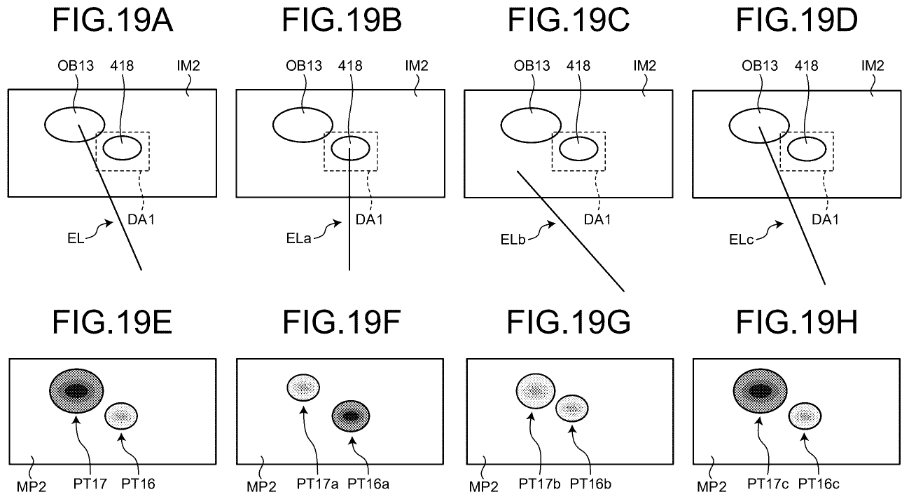

For example, let us presume that a display object 418 is added to the display area DA1 in the image IM1 in which an object OB13 to be noted is present at a position away from the display area DA1 on the road surface 600, whereby an image IM2 illustrated in FIG. 19A is generated. The evaluation unit 224 specifies a position PS1 of a viewpoint corresponding to a line-of-sight EL of the driver 200 in accordance with the line-of-sight information. The evaluation unit 224 can obtain the position PS1 of the viewpoint of the driver 200 as the position of an intersection between the line-of-sight EL of the driver 200 and the virtual screen 500 (see FIG. 1). FIG. 19A illustrates an exemplary case where the position PS1 of the viewpoint is on the object OB13. The evaluation unit 224 specifies a center position PS11 of a pattern PT17 whose novelty level is greater than or equal to the threshold level Lth1 in map information MP2 illustrated in FIG. 19E. The evaluation unit 224 may obtain a distance D1 between the position PS1 and the position PS11.

Similarly, an image IM2 illustrated in FIG. 19B is generated, and the evaluation unit 224 specifies a position PS2 of the viewpoint corresponding to a line of sight ELa of the driver 200 in accordance with the line-of-sight information. FIG. 19B illustrates an exemplary case where the position PS1 of the viewpoint is on the display object 418. The evaluation unit 224 specifies a center position PS12 of a pattern PT16a whose novelty level is greater than or equal to the threshold level Lth1 in map information MP2 illustrated in FIG. 19F. The evaluation unit 224 may obtain a distance D2 between the position PS2 and the position PS12.

An image IM2 illustrated in FIG. 19C is generated, and the evaluation unit 224 specifies a position PS3 of the viewpoint corresponding to a line of sight ELb of the driver 200 in accordance with the line-of-sight information. FIG. 19C illustrates an exemplary case where the position PS3 of the viewpoint is separated from both the object OB13 and the display object 418. The evaluation unit 224 specifies that there is no pattern whose novelty level is greater than or equal to the threshold level Lth1 in map information MP2 illustrated in FIG. 19G.

An image IM2 illustrated in FIG. 19D is generated, and the evaluation unit 224 specifies a position PS4 of the viewpoint corresponding to a line of sight ELc of the driver 200 in accordance with the line-of-sight information. FIG. 19D illustrates an exemplary case where the position PS4 of the viewpoint is on the object OB13. The evaluation unit 224 specifies a position PS14 of a pattern PT16c whose novelty level is greater than or equal to the threshold level Lth1 in map information MP2 illustrated in FIG. 19H. The evaluation unit 224 may obtain a distance D4 between the position PS4 and the position PS14.

The evaluation unit 224 obtains the strength of the correlation between the line of sight of the driver 200 and the attention state of the driver depending on the positions of the viewpoints in the images IM2 illustrated in FIGS. 19A, 19B, and 19D and the positions of the patterns whose novelty level is greater than or equal to the threshold level Lth1 in the map information MP2 illustrated in FIGS. 19E, 19F, and 19H. Since there is no pattern having a novelty level greater than or equal to the threshold level Lth1 in the map information MP2 illustrated in FIG. 19G, the image IM2 illustrated in FIG. 19C and the map information MP2 illustrated in FIG. 19G may be excluded from the evaluation target. The evaluation unit 224 generates and holds the correlation information 2241 including the strength of the correlation.

The evaluation unit 224 may obtain an average distance AD1 by averaging the distances D1, D2, and D4 as a value indicating the strength of the correlation. The closer the average distance AD1 is to 0, the stronger the correlation between the line of sight of the driver 200 and the attention state of the driver is. The evaluation unit 224 may generate correlation information 2241 including the average distance AD1 and store the correlation information 2241 in the nonvolatile storage unit 16 (see FIG. 3).

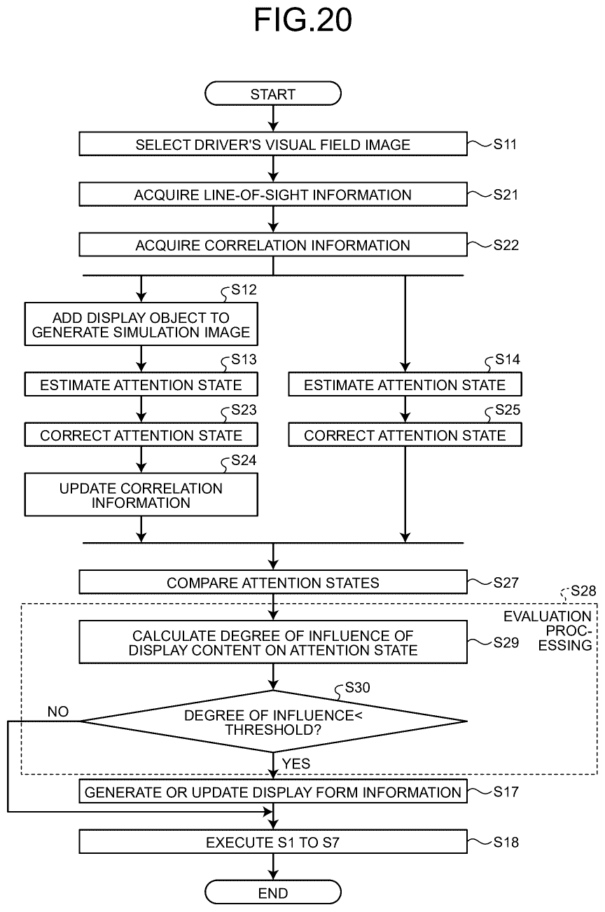

Meanwhile, as illustrated in FIG. 20, the display control method executed by the display control system 202 is different from the second embodiment in the following points. FIG. 20 is a flowchart illustrating a display control method according to a first modification of the second embodiment.

After S11, the display control device 201 acquires line-of-sight information indicating the line of sight of the driver 200 (S21). For example, the imaging sensor 226 captures an image of the imaging range VF12 and acquires an image of the pupils of the eyeballs of the driver 200, and line-of-sight information about the direction of the line of sight of the driver 200 is extracted from the image signal indicating the image of the pupils.

The display control device 201 acquires correlation information 2241 indicating the correlation between the line of sight of the driver and the attention state of the driver (S22). The display control device 201 may acquire the correlation information 2241 by reading the correlation information 2241 from the nonvolatile storage unit 16.

After S22, processing of S12 to S24 and processing of S14 to S25 are performed in parallel.

In the processing of S12 to S24, the display control device 201 generates the image IM2 as a simulation image by adding the display object 400 to the display area DA1 in the image IM1 in the display form DF1 (S12).

The display control device 201 applies an attention estimation model 7 to the image IM2 to estimate the attention state of the driver 200 (S13) and generates an estimation result of the attention state with respect to the image IM2. For example, the display control device 201 may apply a novelty estimation model 7_1 to the image IM2 to generate map information MP2 indicating a two-dimensional distribution of prediction errors corresponding to the image IM2 and generate an estimation result of the attention state including the image IM2 and the map information MP2.

The display control device 201 corrects the estimation result of the attention state in S13 in accordance with the line-of-sight information in S21 and the correlation information in S22 (S23). The display control device 201 may correct the estimation result of the attention state using the average distance AD1 included in the correlation information and the distance D5 between the position of the viewpoint corresponding to the line of sight EL included in the line-of-sight information and the position of the pattern included in the estimation result of S13. For example, the display control device 201 may correct the estimation result of the attention state in S13 by subtracting the distance D5 from the average distance AD1 to obtain a difference DF2 and correcting the position of the pattern in the map information MP2 such that the difference DF2 is canceled out.

The display control device 201 updates the correlation information (S24). For example, the display control device 201 may obtain an average distance AD2 by averaging after addition of the distance D5 to the distances D1, D2, and D4. The display control device 201 may generate correlation information 2241 including the average distance AD2 and store the correlation information 2241 in the nonvolatile storage unit 16 (see FIG. 3) by overwriting the correlation information 2241. As a result, the correlation information 2241 can be overwritten and updated.

Meanwhile, in processing of S14 to S25, the display control device 201 applies the attention estimation model 7 to the image IM1, estimates the attention state of the driver 200 (S14), and generates an estimation result of the attention state with respect to the image IM1. For example, the display control device 201 may apply the novelty estimation model 7_1 to the image IM2 to generate the map information MP2 indicating a two-dimensional distribution of prediction errors corresponding to the image IM2 and generate an estimation result of the attention state including the image IM2 and the map information MP2.

The display control device 201 corrects the estimation result of the attention state in S14 in accordance with the line-of-sight information in S21 and the correlation information in S22 (S25). The display control device 201 may correct the estimation result of the attention state using the average distance AD1 included in the correlation information and a distance D6 between the position of the viewpoint corresponding to the line of sight EL included in the line-of-sight information and the position of the pattern included in the estimation result of S14. For example, the display control device 201 may correct the estimation result of the attention state in S14 by subtracting the distance D6 from the average distance AD1 to obtain a difference DF1 and correcting the position of the pattern in the map information MP1 such that the difference DF1 is canceled out.

When both the processing of S12 to S24 and the processing of S14 to S25 are completed, the display control device 201 evaluates the influence of the display object 400 on the attention state with respect to the image IM1 depending on the estimation result of the attention state with respect to the image IM1 and the estimation result of the attention state with respect to the image IM2.

That is, the display control device 201 compares the estimation result of the attention state corrected in S23 with the estimation result of the attention state corrected in S25 (S27) and performs evaluation processing depending on the comparison result (S28).

In the evaluation processing (S28), the display control device 201 calculates the degree of influence of the display object 400 on the image IM1 depending on the comparison result (S29). The display control device 201 convolutionally integrates values in the map information MP1 with respect to a region near an object to be noted and a region near the display object 400. The display control device 201 convolutionally integrates values in the map information MP2 with respect to a region near an object to be noted and a region near the display object 400. The display control device 201 may calculate the degree of influence of the display object 400 on the image IM1 by dividing the difference between the integrated value of the map information MP1 and the integrated value of the map information MP2 by the maximum integrated value in the map information MP1.

If the degree of influence is smaller than a threshold (Yes in S30), the display control device 201 determines the display form and generates or updates the display form information 82 depending on the evaluation result in S28 (S17).

If the degree of influence is equal to or greater than the threshold (No in S30), the display control device 201 skips S17.

Then, the display control device 201 performs the processing of S1 to S7 in FIG. 5 (S18).

Also by such a display control method, in such a case where displaying the display object 400 in the display form DF1 results in excessive attention focused on the display object 400 in the field of view VF1, the display form of the display object 400 in which attention is suppressed as compared with the display form DF1 can be determined as the display form DF2 depending on the evaluation result.

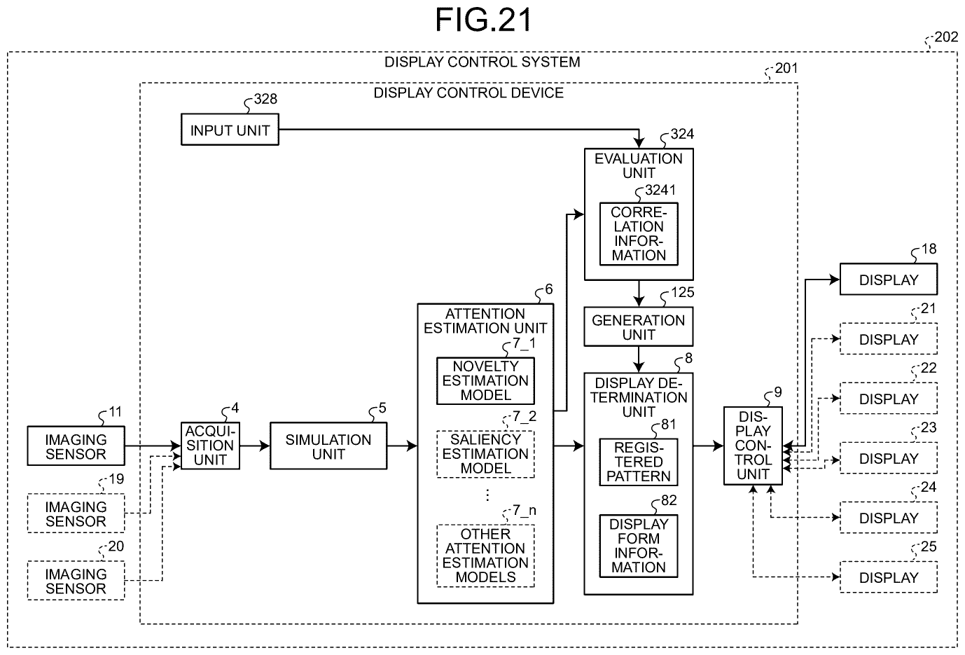

In addition, as a second modification of the second embodiment, evaluation for determining the display form may be performed in further consideration of correlation between subjective evaluation by the driver and the attention state of the driver. In this case, as illustrated in FIG. 21, a display control system 302 includes a display control device 301 instead of the display control device 101 (see FIG. 14). The display control device 301 further includes an input unit 328. FIG. 21 is a diagram illustrating a functional configuration of the display control device 301 according to the second modification of the second embodiment.

The input unit 328 receives subjective evaluation information regarding the subjective evaluation of the attention state in a visual field image from the driver 200. The input unit 328 supplies the subjective evaluation information to an evaluation unit 224.

The evaluation unit 224 receives the subjective evaluation information from the input unit 328 and receives an estimation result of the attention state with respect to the image IM2 from the attention estimation unit 6. The evaluation unit 224 may generate correlation information 3241 indicating correlation between the subjective evaluation by the driver and the attention state of the driver depending on the subjective evaluation information and the estimation result of the attention state with respect to the image IM2.

For example, let us presume that the display object 418 is added to the display area DA1 in the image IM1 in which the object OB13 to be noted is present at a position away from the display area DA1 on the road surface 600, whereby an image IM2 illustrated in FIG. 19A is generated. It is based on the premise that the subjective evaluation information indicates that the attention of the driver 200 is focused on the object OB13. The evaluation unit 224 specifies that the pattern PT17 having a novelty level greater than or equal to the threshold level Lth1 in the map information MP2 illustrated in FIG. 19E corresponds to the object OB13. The evaluation unit 224 evaluates that the subjective evaluation by the driver corresponds to the attention state estimated by the evaluation unit 224 depending on the image IM2 illustrated in FIG. 19A, the map information MP2 illustrated in FIG. 19E, and the subjective evaluation information and that the correlation between the two is strong.

Similarly, let us presume that the image IM2 illustrated in FIG. 19B is generated. It is based on the premise that the subjective evaluation information indicates that the attention of the driver 200 is focused on the display object 418. The evaluation unit 224 specifies that the pattern PT16a having a novelty level greater than or equal to the threshold level Lth1 in the map information MP2 illustrated in FIG. 19F corresponds to the display object 418. The evaluation unit 224 evaluates that the subjective evaluation by the driver corresponds to the attention state estimated by the evaluation unit 224 depending on the image IM2 illustrated in FIG. 19B, the map information MP2 illustrated in FIG. 19F, and the subjective evaluation information and that the correlation between the two is strong. The evaluation unit 224 may divide the number of times the two match each other by the number of times of evaluation to obtain the coincidence probability as a value indicating the strength of the correlation between the two.

The evaluation unit 224 may generate the correlation information 2241 indicating a strong correlation between the subjective evaluation by the driver and the attention state and store the correlation information 2241 in the nonvolatile storage unit 16 (see FIG. 3). The evaluation unit 224 may generate the correlation information 2241 including the coincidence probability and store the correlation information 2241 in the nonvolatile storage unit 16.

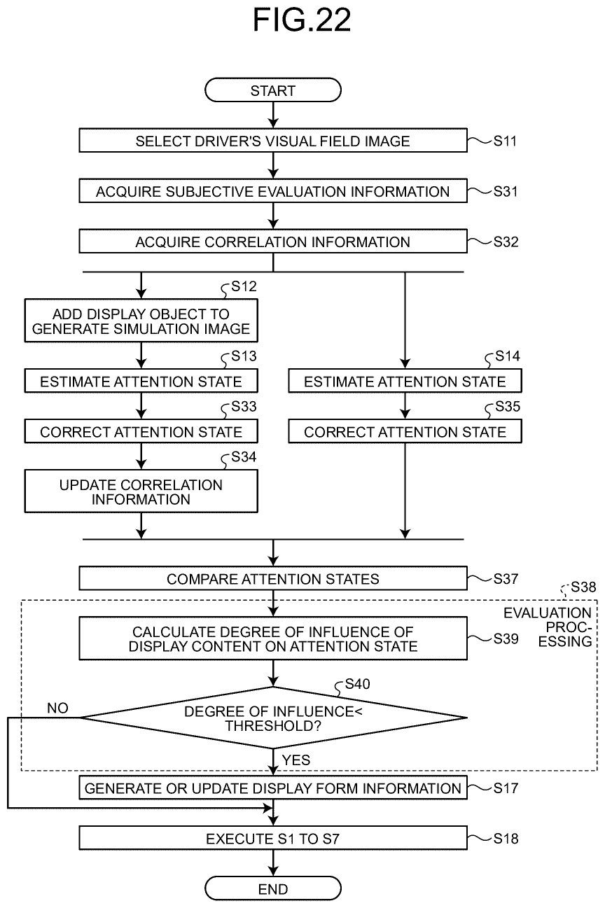

Meanwhile, as illustrated in FIG. 22, the display control method executed by the display control system 202 is different from the second embodiment in the following points. FIG. 22 is a flowchart illustrating a display control method according to the second modification of the second embodiment.

After S11, the display control device 301 acquires the subjective evaluation information indicating the subjective evaluation by the driver 200 (S31). For example, the subjective evaluation information regarding the subjective evaluation of the attention state in a visual field image can be received from the driver 200, whereby the subjective evaluation information can be acquired.

The display control device 301 acquires correlation information 3241 indicating the correlation between the subjective evaluation by the driver and the attention state of the driver (S32). The display control device 301 may acquire the correlation information 3241 by reading the correlation information 3241 from the nonvolatile storage unit 16.

After S32, processing of S12 to S34 and processing of S14 to S35 are performed in parallel.

In the processing of S12 to S34, the display control device 201 generates the image IM2 as a simulation image by adding the display object 400 to the display area DA1 in the image IM1 in the display form DF1 (S12).

The display control device 301 applies an attention estimation model 7 to the image IM2 to estimate the attention state of the driver 200 (S13) and generates an estimation result of the attention state with respect to the image IM2. For example, the display control device 301 may apply the novelty estimation model 7_1 to the image IM2 to generate the map information MP2 indicating a two-dimensional distribution of prediction errors corresponding to the image IM2 and generate an estimation result of the attention state including the image IM2 and the map information MP2.

The display control device 301 corrects the estimation result of the attention state in S13 in accordance with the subjective evaluation information in S31 and the correlation information in S32 (S33). In a case where the correlation information indicates that the correlation between the subjective evaluation by the driver and the estimation result of the attention state is strong (for example, in a case where the coincidence probability is greater than or equal to a predetermined value), the display control device 301 may correct the estimation result of the attention state such that the estimation result corresponds to the subjective evaluation information in S31. For example, the display control device 301 may leave the estimation result of the attention state in S13 as it is if an object to be noted in the estimation result of the attention state matches the subjective evaluation information. If the object to be noted in the estimation result of the attention state does not match the subjective evaluation information, the display control device 301 may change the estimation result of the attention state in S13 such that the estimation result matches the subjective evaluation information.

The display control device 301 updates the correlation information (S34). For example, the display control device 301 may increment the number of times of evaluation, divide the number of times of coincidence between the two by the number of times of evaluation to obtain the coincidence probability, generate the correlation information 3241 including the coincidence probability, and overwrite and store the correlation information 3241 in the nonvolatile storage unit 16. As a result, the correlation information 3241 can be overwritten and updated.

Meanwhile, in processing of S14 to S35, the display control device 301 applies the attention estimation model 7 to the image IM1, estimates the attention state of the driver 200 (S14), and generates an estimation result of the attention state with respect to the image IM1. For example, the display control device 301 may apply the novelty estimation model 7_1 to the image IM2 to generate the map information MP2 indicating a two-dimensional distribution of prediction errors corresponding to the image IM2 and generate an estimation result of the attention state including the image IM2 and the map information MP2.

The display control device 301 corrects the estimation result of the attention state in S14 in accordance with the subjective evaluation information in S31 and the correlation information in S32 (S35). In a case where the correlation information indicates that the correlation between the subjective evaluation by the driver and the estimation result of the attention state is strong (for example, in a case where the coincidence probability is greater than or equal to a predetermined value), the display control device 301 may correct the estimation result of the attention state such that the estimation result corresponds to the subjective evaluation information in S31. For example, the display control device 301 may leave the estimation result of the attention state in S14 as it is if an object to be noted in the estimation result of the attention state matches the subjective evaluation information. If the object to be noted in the estimation result of the attention state does not match the subjective evaluation information, the display control device 301 may change the estimation result of the attention state in S14 such that the estimation result matches the subjective evaluation information.

When both the processing of S12 to S34 and the processing of S14 to S35 are completed, the display control device 301 evaluates the influence of the display object 400 on the attention state with respect to the image IM1 depending on the estimation result of the attention state with respect to the image IM1 and the estimation result of the attention state with respect to the image IM2.

That is, the display control device 301 compares the estimation result of the attention state corrected in S33 with the estimation result of the attention state corrected in S35 (S37) and performs evaluation processing depending on the comparison result (S38).

In the evaluation processing (S38), the display control device 301 calculates the degree of influence of the display object 400 on the image IM1 depending on the comparison result (S39). The display control device 301 convolutionally integrates values in the map information MP1 with respect to a region near an object to be noted and a region near the display object 400. The display control device 301 convolutionally integrates values in the map information MP2 with respect to a region near an object to be noted and a region near the display object 400. The display control device 301 may calculate the degree of influence of the display object 400 on the image IM1 by dividing the difference between the integrated value of the map information MP1 and the integrated value of the map information MP2 by the maximum integrated value in the map information MP1.

If the degree of influence is smaller than a threshold (Yes in S40), the display control device 301 determines the display form and generates or updates the display form information 82 depending on the evaluation result in S38 (S17).

If the degree of influence is equal to or greater than the threshold (No in S40), the display control device 301 skips S17.

Then, the display control device 301 performs the processing of S1 to S7 in FIG. 5 (S18).

Also by such a display control method, in such a case where displaying the display object 400 in the display form DF1 results in excessive attention focused on the display object 400 in the field of view VF1, the display form of the display object 400 in which attention is suppressed as compared with the display form DF1 can be determined as the display form DF2 depending on the evaluation result.

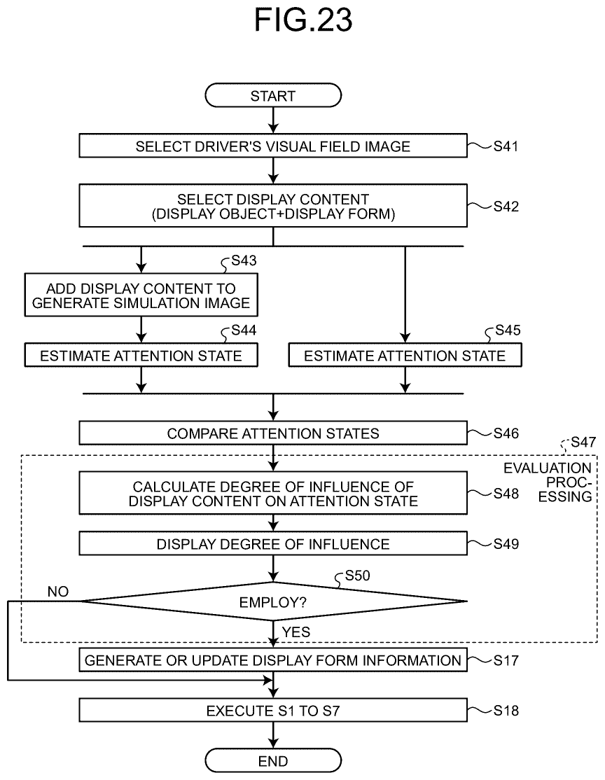

As a third modification of the second embodiment, display control as illustrated in FIG. 23 may be performed. FIG. 23 is a flowchart illustrating a display control method according to the third modification of the second embodiment.

In the display control system 302, the display control device 301 selects an image to be evaluated from among a plurality of images IM1 captured by an imaging sensor 11 as a visual field image (S41). For example, the display control device 301 acquires a plurality of images IM1 captured by the imaging sensor 11. The display control device 301 may receive a selection instruction to select one of the plurality of images IM1 and select the image IM1 selected by the selection instruction as the visual field image.

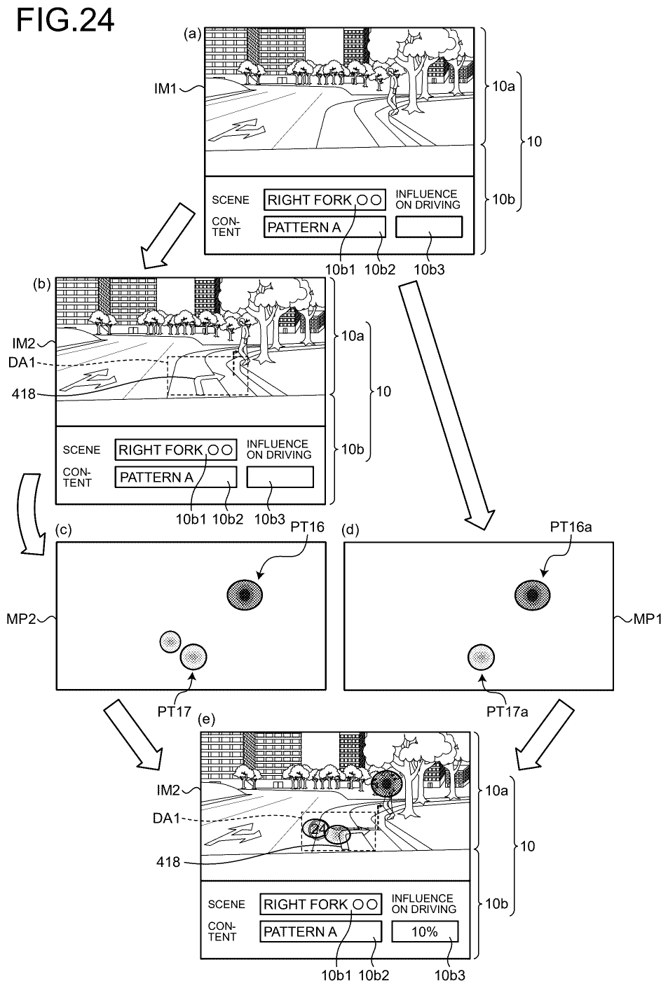

For example, the display unit 10 (see FIG. 3) illustrated at (a) in FIG. 24 may display an image display screen 10a and an information display screen 10b. FIG. 24 is a diagram illustrating a display control method according to a third modification of the second embodiment. The information display screen 10b includes a scene input field 10b1, a content input field 10b2, and a driving influence display field 10b3.

The scene input field 10b1 can receive a selection instruction for selecting one image IM1 from among the plurality of images IM1 as a scene to be evaluated. In the scene input field 10b1, thumbnail images of the plurality of images IM1 may be displayed in a drop-down manner in response to a selection operation of the scene input field 10b1, or a selection instruction of an image IM1 corresponding to a thumbnail image may be received in response to a selection operation of the thumbnail image. In the scene input field 10b1, identification information (for example, XX right fork) of an image IM1 selected by the selection instruction can be displayed.

The display control device 301 selects display content (S42). The display content includes a display object and a display form thereof. For example, in the display control device 301, a plurality of pieces of display content are generated in advance and stored in the nonvolatile storage unit 16 (see FIG. 3). The display control device 301 may receive a selection instruction for selecting one piece of display content from among the plurality of pieces of display content and select the display content selected by the selection instruction as display content to be evaluated.

For example, in the display unit 10 illustrated at (a) in FIG. 24, the content input field 10b2 of the information display screen 10b can receive a selection instruction for selecting one piece of display content from among the plurality of pieces of display content as a pattern to be evaluated. In the content input field 10b2, thumbnail images of the plurality of piece of display content may be displayed in a drop-down manner in response to a selection operation of the content input field 10b2, or a selection instruction of display content corresponding to a thumbnail image may be received in response to a selection operation of the thumbnail image. In the content input field 10b2, identification information (for example, pattern A) of the display content selected by the selection instruction can be displayed.

After S42, processing of S43 to S44 and processing of S45 are performed in parallel.

In the processing of S43 to S44, the display control device 301 adds the display content in S42 to the display area DA1 in the image IM1 and thereby generates an image IM2 as a simulation image (S43). The display content includes displaying a display object 418 in a display form DF2.

For example, in the display unit 10 illustrated at (b) in FIG. 24, the image IM2 is displayed on the image display screen 10a. In the display area DA1 of the image IM2, the display object 418 is displayed in the display form DF2.

The display control device 301 applies an attention estimation model 7 to the image IM2 to estimate the attention state of the driver 200 (S44) and generates an estimation result of the attention state with respect to the image IM2. For example, the display control device 301 may apply the novelty estimation model 7_1 to the image IM2 to generate the map information MP2 indicating a two-dimensional distribution of prediction errors corresponding to the image IM2 and generate an estimation result of the attention state including the image IM2 and the map information MP2.

For example, the attention estimation model 7 is applied to the image IM2 at (b) in FIG. 24, the attention state of the driver 200 is estimated, and map information MP2 as illustrated at (c) in FIG. 24 is generated. In the map information MP2, by referring to the image IM2, it is indicated that a pattern PT16b, whose novelty level is greater than or equal to a threshold level Lth2, is included at a position away from the display area DA1. The threshold level Lth2 can be experimentally determined in advance as a novelty level corresponding to the need for attention.

Meanwhile, in the processing of S45, the display control device 301 applies the attention estimation model 7 to the image IM1, estimates the attention state of the driver 200, and generates an estimation result of the attention state with respect to the image IM1.

For example, the attention estimation model 7 is applied to an image IM1 at (a) in FIG. 24, the attention state of the driver 200 is estimated, and map information MP1 as illustrated at (d) in FIG. 24 is generated. In the map information MP1, by referring to the image IM1, it is indicated that a pattern PT16b whose novelty level is greater than or equal to the threshold level Lth2 is included at a position away from the display area DA1. The threshold level Lth2 can be experimentally determined in advance as a novelty level corresponding to the need for attention.

When both the processing of S43 to S44 and the processing of S45 are completed, the display control device 301 evaluates the influence of the display object 400 on the attention state with respect to the image IM1 depending on the estimation result of the attention state with respect to the image IM1 and the estimation result of the attention state with respect to the image IM2.

That is, the display control device 101 compares the estimation result of the attention state obtained in S11 with the estimation result of the attention state obtained in S3 (S46) and performs evaluation processing depending on the comparison result (S47).

In the evaluation processing (S47), the display control device 301 calculates the degree of influence of the display content on the image IM1 depending on the comparison result (S48) and displays the calculated degree of influence (S49).

For example, in the display unit 10 illustrated at (e) in FIG. 24, the degree of influence is displayed in the driving influence display field 10b3. FIG. 24 illustrates, at (e), an exemplary case where the degree of influence of “10%” is displayed in the driving influence display field 10b3.

The display control device 301 receives an instruction regarding employment of display content and determines whether or not to employ display content depending on the instruction (S50). In a case where an instruction indicating employment of display content, the display control device 301 determines the display form and generates or updates the display form information 82 depending on the evaluation result in S47 on the basis of the premise that the display content is employed (Yes in S50) (S17).

If an instruction indicating rejection of the display content is received, the display control device 301 determines not to employ the display content (No in S50) and skips S17.

Then, the display control device 301 performs the processing of S1 to S7 in FIG. 5 (S18).

Also by such a display control method, in such a case where displaying the display object 400 in the display form DF1 results in excessive attention focused on the display object 400 in the field of view VF1, the display form of the display object 400 in which attention is suppressed as compared with the display form DF1 can be determined as the display form DF2 depending on the evaluation result.

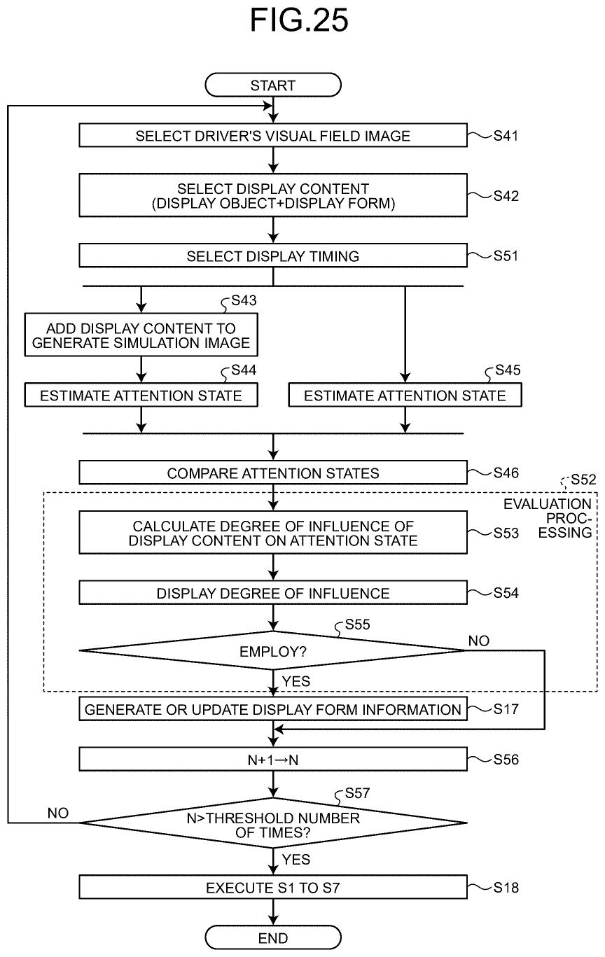

As a fourth modification of the second embodiment, display control as illustrated in FIG. 25 may be performed. FIG. 25 is a flowchart illustrating the display control method according to the fourth modification of the second embodiment.

In the display control system 302, the display control device 301 sets an initial value 0 to a parameter N for counting the number of loops, performs S41 and S42 (see FIG. 23), and then selects display timing (S51). For example, in the display control device 301, a plurality of pieces of display content are generated in advance and stored in the nonvolatile storage unit 16 (see FIG. 3). Each piece of display content includes a display object and a display form thereof, and the display form may include display timing. The display control device 301 may receive an instruction for selecting a display timing from among different display timings and select the display timing selected by the instruction as the display timing to be evaluated.

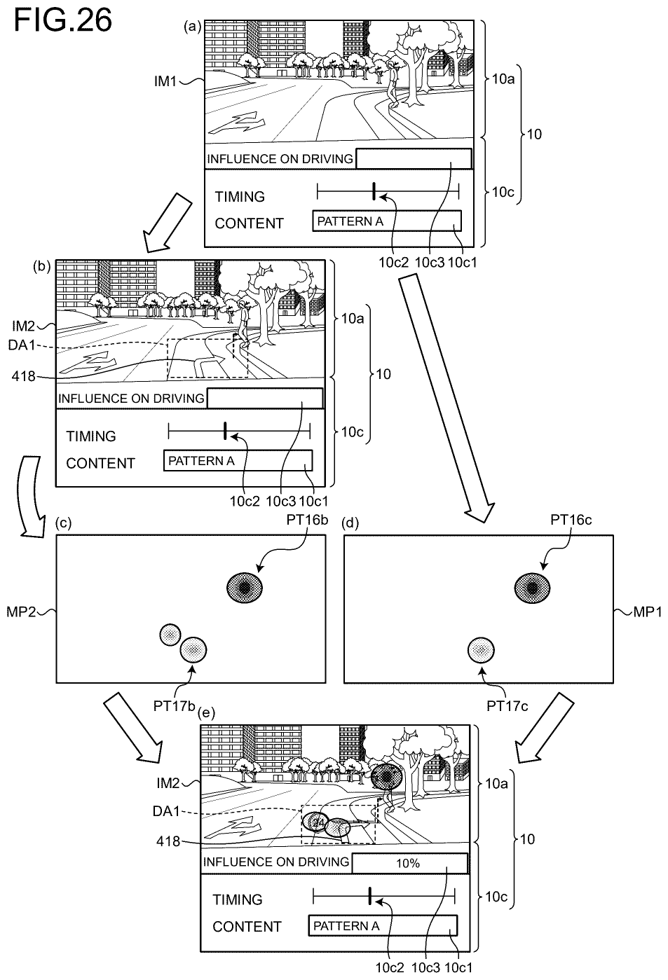

For example, in the display unit 10 illustrated at (a) in FIG. 26, an information display screen 10c includes a content input field 10b1, a timing input field 10b2, and a driving influence display field 10c3. In the content input field 10b2, identification information (for example, pattern A) of the display content selected in response to the selection instruction of the content in S42 can be displayed. The display content may include the display form DF2. The timing input field 10b2 can accept a bar moving operation and a bar thickness selecting operation. The timing at which the display object 400 starts to be displayed can be modified by a bar moving operation from timing immediately after to timing delayed by time Δt. A display time ΔT for displaying the display object 400 can be modified by the bar thickness selecting operation. FIG. 26 illustrates, at (a), an exemplary case where the bar thickness selecting operation is performed such that the display time ΔT is relatively short. The display form DF2 includes a relatively short display time ΔT.

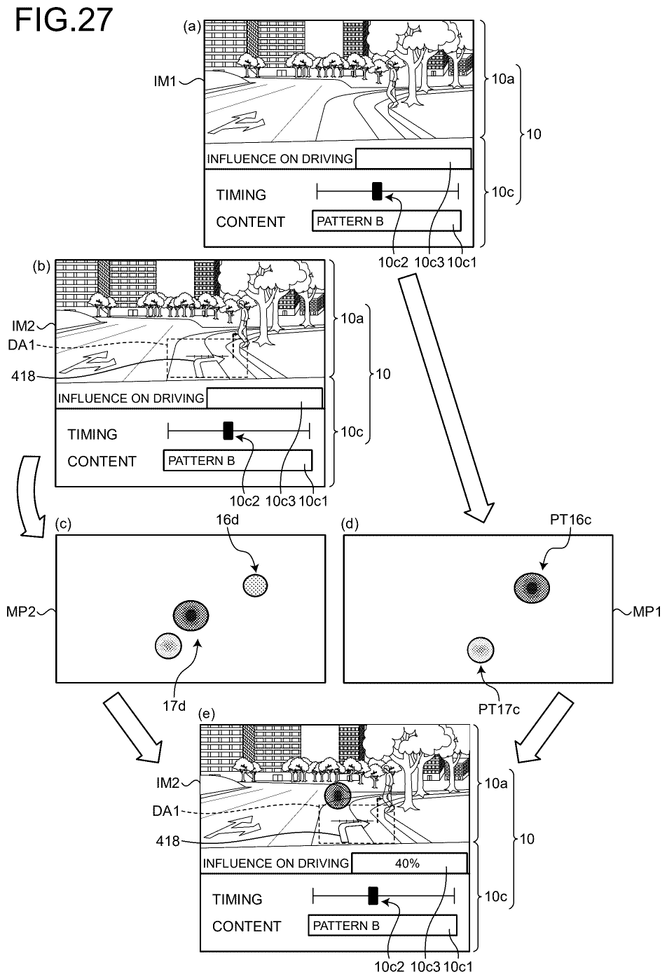

Alternatively, in the display unit 10 illustrated at (a) in FIG. 27, the information display screen 10c includes a content input field 10b1, a timing input field 10b2, and a driving influence display field 10c3. In the content input field 10b2, identification information (for example, pattern B) of the display content selected in response to the selection instruction of the content in S42 can be displayed. The display content may include the display form DF1. FIG. 27 illustrates, at (a), an exemplary case where the bar thickness selecting operation is performed such that the display time ΔT is relatively long. The display form DF1 includes a relatively long display time ΔT.

After S51, the processing of S43 to S44 and the processing of S45 are performed in parallel.

In the processing of S43 to S44, the display control device 301 adds the display content in S42 to the display area DA1 in the image IM1 and thereby generates an image IM2 as a simulation image (S43).

For example, in the display unit 10 illustrated at (b) in FIG. 26, the image IM2 is displayed on the image display screen 10a. In the display area DA1 of the image IM2, the display object 418 is displayed in the display form DF2. The display form DF2 includes a relatively short display time ΔT.

Alternatively, in the display unit 10 illustrated at (b) in FIG. 27, an image IM2 is displayed on the image display screen 10a. In the display area DA1 of the image IM2, the display object 418 is displayed in the display form DF1. The display form DF1 includes a relatively long display time ΔT.

The display control device 301 applies an attention estimation model 7 to the image IM2 to estimate the attention state of the driver 200 (S44) and generates an estimation result of the attention state with respect to the image IM2. For example, the display control device 301 may apply the novelty estimation model 7_1 to the image IM2 to generate the map information MP2 indicating a two-dimensional distribution of prediction errors corresponding to the image IM2 and generate an estimation result of the attention state including the image IM2 and the map information MP2.

For example, the attention estimation model 7 is applied to the image IM2 at (b) in FIG. 26, the attention state of the driver 200 is estimated, and map information MP2 as illustrated at (c) in FIG. 26 is generated. In the map information MP2, by referring to the image IM2, it is indicated that a pattern PT16b, whose novelty level is greater than or equal to a threshold level Lth2, is included at a position away from the display area DA1. The threshold level Lth2 can be experimentally determined in advance as a novelty level corresponding to the need for attention.

Alternatively, the attention estimation model 7 is applied to the image IM2 at (b) in FIG. 27, the attention state of the driver 200 is estimated, and map information MP2 as illustrated at (c) in FIG. 27 is generated. In the map information MP2, by referring to the image IM2, it is indicated that a pattern PT16b, whose novelty level is greater than or equal to a threshold level Lth2, is included at a position away from the display area DA1. The threshold level Lth2 can be experimentally determined in advance as a novelty level corresponding to the need for attention.

Meanwhile, in the processing of S45, the display control device 301 applies the attention estimation model 7 to the image IM1, estimates the attention state of the driver 200, and generates an estimation result of the attention state with respect to the image IM1.

For example, the attention estimation model 7 is applied to an image IM1 at (a) in FIG. 26, the attention state of the driver 200 is estimated, and map information MP1 as illustrated at (d) in FIG. 26 is generated. In the map information MP1, by referring to the image IM1, it is indicated that a pattern PT16c whose novelty level is greater than or equal to the threshold level Lth2 is included at a position away from the display area DA1. The threshold level Lth2 can be experimentally determined in advance as a novelty level corresponding to the need for attention.

Alternatively, the attention estimation model 7 is applied to an image IM1 at (a) in FIG. 27, the attention state of the driver 200 is estimated, and map information MP1 as illustrated at (d) in FIG. 27 is generated. In the map information MP1, by referring to the image IM1, it is indicated that a pattern PT16c whose novelty level is greater than or equal to the threshold level Lth2 is included at a position away from the display area DA1. The threshold level Lth2 can be experimentally determined in advance as a novelty level corresponding to the need for attention.

When both the processing in S43 to S44 and the processing in S45 are completed, the display control device 301 compares the estimation result of the attention state obtained in S44 with the estimation result of the attention state obtained in S45 (S46) and performs evaluation processing depending on the comparison result (S52).

In the evaluation processing (S52), the display control device 301 calculates the degree of influence of the display content on the image IM1 depending on the comparison result (S53) and displays the calculated degree of influence (S54).

For example, in the display unit 10 illustrated at (e) in FIG. 26, the degree of influence is displayed in the driving influence display field 10c3. At (e) in FIG. 26 illustrates an exemplary case where the degree of influence of “10%” is displayed in the driving influence display field 10b3.

Alternatively, in the display unit 10 illustrated at (e) in FIG. 27, the degree of influence is displayed in the driving influence display field 10c3. FIG. 27 illustrates, at (e), an exemplary case where the degree of influence of “40%” is displayed in the driving influence display field 10b3.

The display control device 301 receives an instruction regarding employment of display content and determines whether or not to employ the display content depending on the instruction (S55). In a case where an instruction indicating employment of display content, the display control device 301 determines the display form and generates or updates the display form information 82 depending on the evaluation result in S52 on the basis of the premise that the display content is employed (Yes in S55) (S17).

If an instruction indicating rejection of the display content is received, the display control device 301 determines not to employ the display content (No in S55) and skips S17.

Then, the display control device 301 increments the parameter N for counting the number of loops (S56) and determines whether or not the parameter N has exceeded a threshold number of times (S57). The threshold number of times can be experimentally determined in advance.

If the parameter N is less than or equal to the threshold number of times (No in S57), the display control device 301 returns the processing to S41.

If the parameter N exceeds the threshold number of times (Yes in S57), the display control device 301 performs the processing of S1 to S7 in FIG. 5 (S18).

Also by such a display control method, in such a case where displaying the display object 400 in the display form DF1 results in excessive attention focused on the display object 400 in the field of view VF1, the display form of the display object 400 in which attention is suppressed as compared with the display form DF1 can be determined as the display form DF2 depending on the evaluation result.

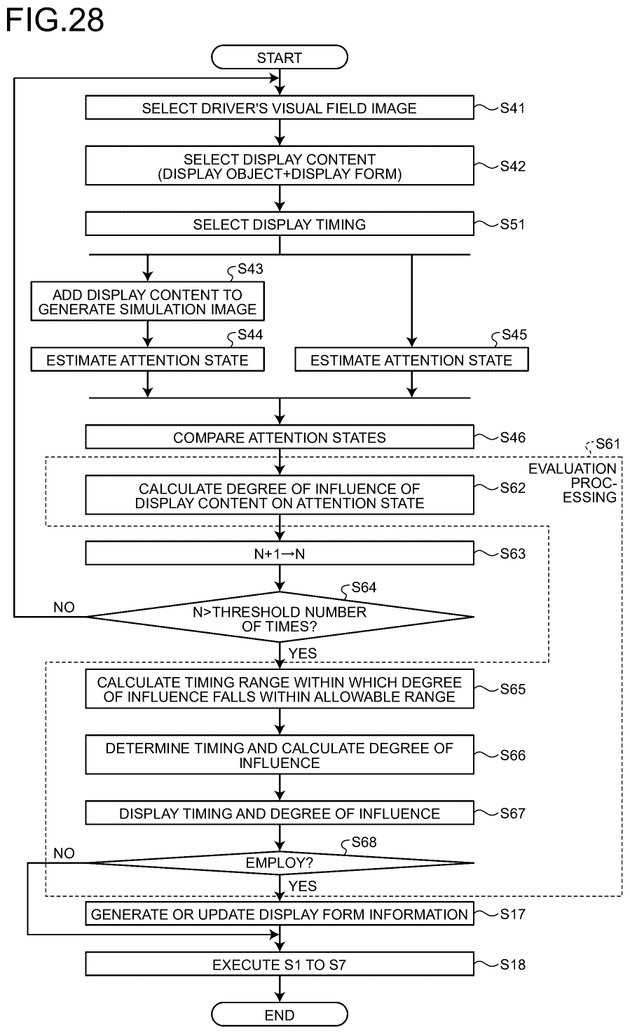

As a fifth modification of the second embodiment, display control as illustrated in FIG. 28 may be performed. FIG. 28 is a flowchart illustrating a display control method according to the fifth modification of the second embodiment.

In the display control system 302, the display control device 301 sets an initial value 0 to a parameter N for counting the number of loops, performs S41 to S46 (see FIG. 25), and then performs a part of the evaluation processing (S61) depending on the comparison result. That is, the display control device 301 calculates the degree of influence of a display content on an image IM1 depending on the comparison result in S46 (S53).

The display control device 301 increments the parameter N for counting the number of loops (S63) and determines whether or not the parameter N has exceeded the threshold number of times (S64).

If the parameter N is less than or equal to the threshold number of times (No in S64), the display control device 301 returns the processing to S41.

If the parameter N exceeds the threshold number of times (Yes in S64), the display control device 301 performs the remaining part of the evaluation processing (S61). That is, the display control device 301 calculates a display timing range in which the degree of influence falls within an allowable range using N pieces of degree of influence calculated in S62 (S65).

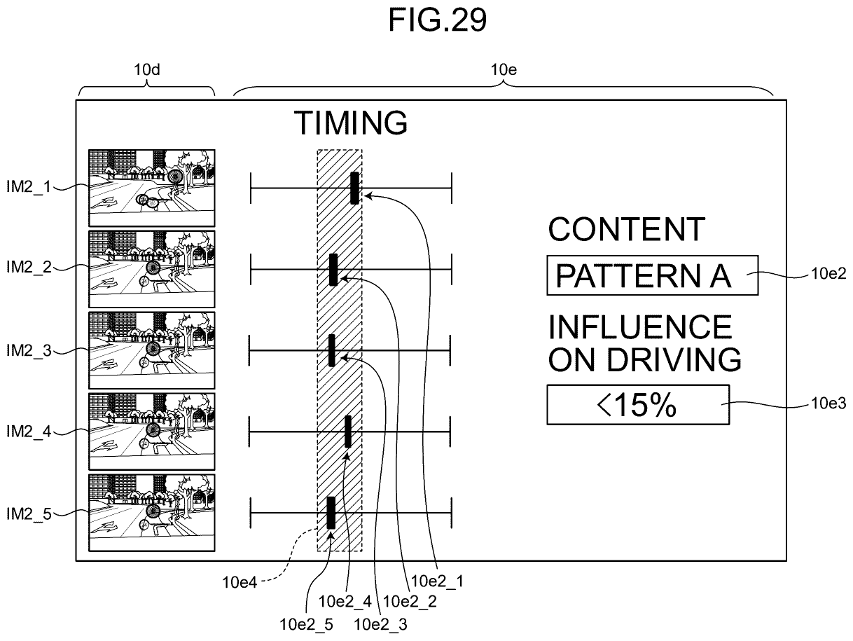

For example, an image display screen 10d and an information display screen 10e may be displayed on the display unit 10 illustrated in FIG. 29. On the image display screen 10d, a plurality of images MI2 whose degree of influence falls within the allowable range can be displayed. FIG. 29 illustrates an exemplary case where five images IM2_1 to IM2_5 whose degree of influence falls within the allowable range are displayed. The information display screen 10e includes a content input field 10e2, a plurality of timing input fields 10e2_1 to 10e2_5, and a driving influence input field 10e3.

A content input field 10e1 of the information display screen 10e can receive a selection instruction for selecting one piece of display content from among a plurality of pieces of display content as a pattern to be evaluated. In the content input field 10e1, thumbnail images of the plurality of piece of display content may be displayed in a drop-down manner in response to a selection operation of the content input field 10e1, or a selection instruction of display content corresponding to a thumbnail image may be received in response to a selection operation of the thumbnail image. In the content input field 10e1, identification information (for example, pattern A) of the display content selected by the selection instruction can be displayed.

The driving influence input field 10e3 can receive the allowable range of the degree of influence. In the driving influence input field 10e3, a plurality of allowable ranges may be displayed in a drop-down manner in response to a selection operation of the driving influence input field 10e3, or an allowable range may be received in response to a selection operation of the allowable range. In the content input field 10e1, the allowable range (for example, <15%) selected by the selection instruction can be displayed.

The plurality of timing input fields 10e2_1 to 10e2_5 correspond to the plurality of images IM2_1 to IM2_5. Each timing input field 10e2 can receive a bar moving operation for display timing of a corresponding image IM2. In addition, in each timing input field 10e2, a range of display timing in which the degree of influence falls within the allowable range is indicated by a frame 10e4 in a range in which the bar moving operation can be performed.

The display control device 301 determines timing using the display timing range calculated in S65, calculates the degree of influence (S66), and displays the timing and the degree of influence (S67).

For example, in the display unit 10 illustrated at (e) in FIG. 26, the display timing is displayed in the timing input field 10b2, and the degree of influence is displayed in the driving influence display field 10c3. FIG. 26 illustrates, at (e), an exemplary case where the degree of influence of “10%” is displayed in the driving influence display field 10b3.

Also by such a display control method, in such a case where displaying the display object 400 in the display form DF1 results in excessive attention focused on the display object 400 in the field of view VF1, the display form of the display object 400 in which attention is suppressed as compared with the display form DF1 can be determined as the display form DF2 depending on the evaluation result.

### Third Embodiment

Next, a display method according to a third embodiment will be described. Hereinafter, parts different from the first embodiment and the second embodiment will be mainly described.

In the second embodiment, evaluation for determining the display form to be changed is illustrated with an example; however, in the third embodiment, an example of performing the evaluation and displaying the evaluation result is illustrated.

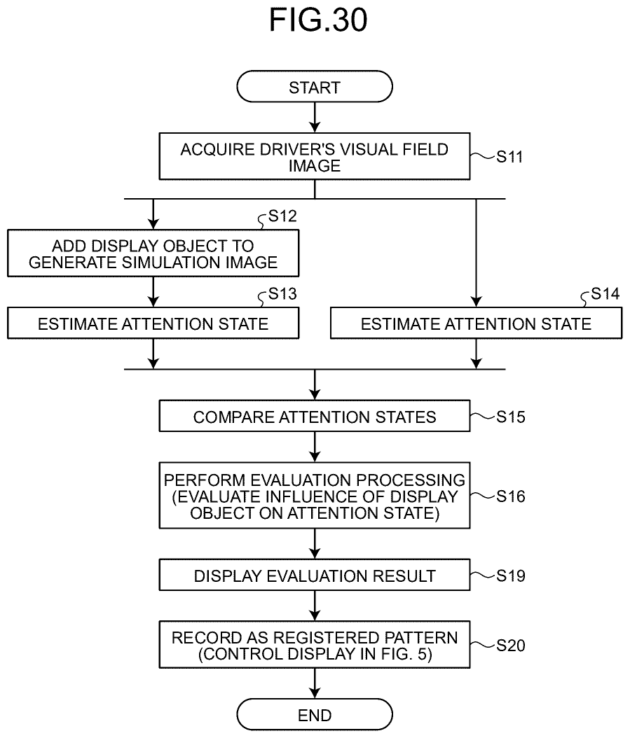

For example, as illustrated in FIG. 30, a display control method executed by a display control system 102 is different from the second embodiment in the following points. FIG. 30 is a flowchart illustrating a display control method according to the third embodiment. In FIGS. 30, S17 and S18 in FIG. 15 are replaced by S19 and S20 (see FIG. 30).

After S11 to S16 are performed similarly to the second embodiment, a display control device 101 displays an evaluation result of S16 on the display unit 10 (see FIG. 3) (S19). The evaluation result of S16 may be a calculation result of the degree of influence as illustrated at (e) in FIG. 16 or at (e) in FIG. 17, superimposed display of a calculation result of the degree of influence as illustrated at (e) in FIG. 24, an image IM2, and map information MP2, or superimposed display of the calculation result of the degree of influence as illustrated at (e) in FIG. 26, at (e) in FIG. 27, or FIG. 29, display of timing, the image IM2, and the map information MP2.

When receiving an instruction that the display form of S19 be included in the registered pattern depending on the display in S19, the display control device 101 records the display form of S19 as the registered pattern 81 to be used for the display control in FIG. 5 (S18).

As described above, in the third embodiment, the display method includes acquiring a visual field image, generating a simulation image from the visual field image, applying an attention estimation model to each of the simulation image and the visual field image, evaluating an influence on the attention state by adding a display object in the display form DF2, and displaying the evaluation result. Also with this method, in such a case where displaying the display object 400 in the display form DF1 results in excessive attention focused on the display object 400 in the field of view VF1, the display form of the display object 400 in which attention is suppressed as compared with the display form DF1 can be determined as the display form DF2 depending on the evaluation result of the display form DF2.

Incidentally, as a first modification of the third embodiment, in a display control method executed by the display control system 102, processing may be performed in which S17 and S18 in FIG. 20 are replaced with S19 and S20 (see FIG. 30).

Alternatively, as a second modification of the third embodiment, in a display control method executed by the display control system 102, processing may be performed in which S17 and S18 in FIG. 22 are replaced with S19 and S20 (see FIG. 30).

Alternatively, as a third modification of the third embodiment, in a display control method executed by the display control system 102, processing may be performed in which S17 and S18 in FIG. 23 are replaced with S19 and S20 (see FIG. 30).

Alternatively, as a fourth modification of the third embodiment, in a display control method executed by the display control system 102, processing may be performed in which S17 and S18 in FIG. 25 are replaced with S19 and S20 (see FIG. 30).

Alternatively, as a fifth modification of the third embodiment, in a display control method executed by the display control system 102, processing may be performed in which S17 and S18 in FIG. 28 are replaced with S19 and S20 (see FIG. 30).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display control method comprising:
acquiring a first image corresponding to a field of view of a driver in a vehicle interior including a display area;
generating a second image by adding, in a first display form, a display object by a display to the display area in the first image;
estimating an attention state of the driver by applying one or more attention estimation models to the second image; and
controlling a display form of the display object to be displayed by the display in the display area in the vehicle interior, depending on an estimation result of the attention state.

2. The display control method according to claim 1,
wherein the controlling the display form includes
changing the display form of the display object from the first display form to a second display form in which attention is suppressed as compared with the first display form, in a case where the estimation result of the attention state is a first estimation result.

3. The display control method according to claim 2,
wherein the controlling the display form further includes
maintaining the display form of the display object in the first display form in a case where the estimation result of the attention state is a second estimation result.

4. The display control method according to claim 1, wherein
the estimating includes generating map information indicating a two-dimensional distribution of prediction errors corresponding to the second image, and
the controlling the display form includes
controlling the display form of the display object from the first display form to a second display form in which attention is suppressed, in a case where an attention state pattern corresponding to the second image and the map information matches a preregistered pattern.

5. The display control method according to claim 4,
wherein the controlling the display form further includes
controlling the display form of the display object to the first display form, in a case where an attention state pattern corresponding to the second image and the map information does not match the preregistered pattern.

6. The display control method according to claim 2, wherein
the first display form includes displaying the display object at first brightness, and
the second display form includes displaying the display object at second brightness lower than the first brightness.

7. The display control method according to claim 2, wherein
the first display form includes displaying the display object at first brightness, and
the second display form includes displaying the display object at brightness gradually increasing from second brightness lower than the first brightness.

8. The display control method according to claim 2, wherein
the first display form includes displaying the display object in a first color, and
the second display form includes displaying the display object in a second color different from the first color in one or more of saturation, brightness, and hue.

9. The display control method according to claim 2, wherein
the first display form includes displaying the display object after a first period of time elapses, and
the second display form includes displaying the display object after a second period of time elapses, the second period of time being longer than the first period of time.

10. A display control method comprising:
acquiring a first image corresponding to a field of view of a driver in a vehicle interior including a display area;
generating a second image by adding, in a first display form, a display object by a display to the display area in the first image;
estimating an attention state of the driver with respect to the first image by applying one or more attention estimation models to the first image;
estimating an attention state of the driver with respect to the second image by applying the one or more attention estimation models to the second image;
evaluating an influence of the display object on the attention state with respect to the first image, depending on an estimation result of the attention state with respect to the first image and an estimation result of the attention state with respect to the second image; and
controlling the display form of the display object to be displayed by the display in the display area in the vehicle interior, depending on the evaluation result.

11. The display control method according to claim 10,
wherein the evaluating includes
evaluating an influence of the display object on the attention state with respect to the first image, depending on correlation among an estimation result of the attention state with respect to the first image, an estimation result of the attention state with respect to the second image, a line of sight of the driver, and the attention state of the driver.

12. The display control method according to claim 10,
wherein the evaluating includes
evaluating an influence of the display object on the attention state with respect to the first image, depending on correlation among an estimation result of the attention state with respect to the first image, an estimation result of the attention state with respect to the second image, a subjective evaluation by the driver, and the attention state of the driver.

13. The display control method according to claim 10, wherein
the estimating for the first image includes
generating first map information indicating a two-dimensional distribution of values of prediction errors corresponding to the first image, variances of the prediction errors, or combinations of values and variances of the prediction errors, and
the estimating for the second image includes
generating second map information indicating a two-dimensional distribution of values of prediction errors corresponding to the second image, variances of the prediction errors, or combinations of values and variances of the prediction errors.

14. The display control method according to claim 13, further comprising:
acquiring line-of-sight information related to a line of sight of the driver; and
acquiring correlation information indicating correlation between the line of sight of the driver and the attention state of the driver, wherein
the estimating for the first image further includes
correcting the first map information in accordance with the line-of-sight information and the correlation information, and
the estimating for the second image further includes
correcting the second map information in accordance with the line-of-sight information and the correlation information.

15. The display control method according to claim 13, further comprising:
acquiring evaluation information related to subjective evaluation of troublesomeness by the driver; and
acquiring correlation information indicating correlation between the subjective evaluation of troublesomeness and the attention state of the driver, wherein
the estimating for the first image further includes
correcting the first map information depending on the evaluation information and the correlation information, and
the estimating for the second image further includes correcting the second map information depending on the evaluation information and the correlation information.

16. A display control device comprising:
a memory; and
a hardware processor coupled to the memory and configured to:
acquire a first image corresponding to a field of view of a driver in a vehicle interior including a display area;
generate a second image by adding, in a first display form, a display object by a display to the display area in the first image;
estimate an attention state of the driver by applying one or more attention estimation models to the second image;
determine a display form of the display object to be displayed by the display in the display area in the vehicle interior, depending on an estimation result of the attention state; and
control the display to display the display object in the display form that has been determined.

17. A display control system comprising:
an imaging sensor;
the display control device according to claim 16 that receives an image acquired by the imaging sensor; and
a display controlled by the display control device.
